(19) United States
(12) Patent Application Publication
(10) Pub. No.: US 2018/0053257 A1
(43) Pub. Date: Feb. 22, 2018

(54) SYSTEMS AND METHODS FOR COVERAGE AGAINST LOSS WITH CLAIM-BASED CONTRIBUTIONS

(71) Applicant: Bisurance Group B.V., Amsterdam (NL)

(72) Inventor: Matthijs Nelemans, Amsterdam (NL)

(21) Appl. No.: 15/682,978

(22) Filed: Aug. 22, 2017

Related U.S. Application Data
(60) Provisional application No. 62/378,010, filed on Aug. 22, 2016.

(51) Int. Cl. G06Q 40/08

(52) U.S. Cl. CPC G06Q 40/08

(57) ABSTRACT

Methods and systems for coverage against loss with claim-based contributions involve presenting no premium insurance options through a portal, and determining, after receipt of certain information from the potential insured entity, a cap-based quote. Users are provided coverage terms and a cap-based quote, which is at least partly based on the level of risk of the user. A preferred payment method and payment details are collected from the user for automated electronic payments initiated by a centralized system. Contributions by insured entities are based on the actual amount to be paid for valid claims in a month (or other time period) and the insured entities' risk profiles (and certain other parameters), and may be zero for the month if there are no claims. The claim-based contributions are automatically collected from the insured entities. Insured entities who have submitted valid claims will receive compensation based on contributions of other insured entities.

### CROSS REFERENCE TO RELATED APPLICATIONS

This application is based on, claims priority to, and incorporates herein by reference in its entirety U.S. Provisional Application Ser. No. 62/378,010, filed Aug. 22, 2016, and entitled, “Systems and Methods for No Premium Insurance.”

### FIELD OF THE INVENTION

This document concerns an invention relating generally to systems and methods that enable users to arrange coverage with each other without involvement of an insurance company. Participants do not pay (upfront) premiums, but rather only a contribution when damages occur in a group of users or otherwise when a claim is filed. This will be referred to as “no premium insurance.” References to insurance in this document should not be interpreted as references to a legal construct, but rather to the concept of insurance, i.e. coverage by contract whereby one or more parties undertake to fully or partly indemnify or guarantee another against loss by a specified contingency or peril.

### BACKGROUND

Insurance is a means of protection from financial loss. It is a form of risk management primarily used to hedge against the risk of a contingent, uncertain loss. Traditionally, an insurance is an agreement between the insured and the insurer, where the insured is obliged to pay an upfront premium to its insurance carrier. When an insured suffers an insured loss, the insured will report the damage to its insurance carrier. Subsequently, the claim will be assessed by the insurance carrier and when considered valid, the insured is compensated from the insurance carrier's aggregated capital. Insurance carriers normally invest considerable parts of their unused aggregated capital in various financial instruments and markets, and to cover costs.

The costs of setting up and maintaining such an insurance scheme greatly exceeds the costs of payouts to the insured in case of a loss. This is because insurance companies use a large part of the premiums to stack up capital for asset management purposes and it is very costly for insurance companies to manage billion-dollar balance sheets, run asset management departments, comply with a vast number of laws and regulations, administer accounts, pay for personnel (such as agents, salespersons, administrative staff, managers, executives, etc.), pay investors as needed, pay for buildings, vehicles, lobbying efforts and other government relations, etc. In the current global insurance system, insurance companies rely heavily on asset management and income thereof while their primary focus should be on insuring people against particular risks. Insurance companies pass on payments for asset management purposes, operational costs and profits to the customer in the form of upfront, monthly premiums, which are normally due without exception. Consequently, this traditional approach means insurance is out of the reach of many potential customers who cannot afford (or are otherwise unwilling) to pay for all the investments and operational costs charged by a traditional insurance provider as part of their premiums. Some may feel they are paying for nothing if over time they receive no payout (because no claim is submitted for a loss) but they nonetheless have to continue paying premiums. This leaves many customers without the protection from certain losses that they need and that could otherwise be secured by an insurance policy.

What is needed is a different, more efficient, and innovative approach to insurance which allows people to share their risks and to cut out unnecessary payments for asset management purposes and operational costs. This would allow more people to afford protection against certain losses.

### SUMMARY

The system and technology described in this document allows for a unique way to insure risks with several benefits, by automatically translating actual claims into contributions at the end of the month (or other period, such as quarter, fortnight, etc.) or even in real-time. This means that insureds (i.e., insured persons/entities) are being charged only for risks that materialize and immediately when they occur or shortly thereafter. They pay the real price of insurance. This is in stark contrast to the current global system in which insurance premiums are paid upfront and are not related to actual and current risks that materialize. One of the main benefits is that people in fact share their risks with the use of technology and protection becomes fundamentally less expensive, by cutting out payments for asset management purposes and unnecessary operational costs. This means protection will become available to more people. What will now be described are various exemplary embodiments of the disclosure.

(i) No Premium Insurance

In example embodiments of this system, users do not pay upfront premiums. Instead, a centralized system/operator (implemented using, e.g., one or more networked servers) collects actual damages of the users in each month (or other period, although for convenience, month will be specified as the period in the following discussion) and divides the amount of the actual damages across the whole user base of the system (or a subset thereof, such as the users covered for the same or similar risks, and/or users in a geographic area, and/or users with similar risk profiles, etc.). If one or more users have a valid claim, the system operator will collect contributions from users to settle the valid claims; that is, the users with valid claims will be reimbursed for the loss (wholly or an agreed portion thereof) for which the claims are filed.

Monthly payments of users are capped at a fixed maximum to limit users' upward risk and provide certainty (and enable better planning/budgeting). A cap may be based on a user's risk-profile. Users would never have to pay more than their cap in various implementations (unless otherwise agreed). Some months, they might pay less than the cap. Or, if there are no claims in a certain month, they might even pay nothing at all.

This approach allows users to pay the real price of insurance, directly based on actual claims. The costs will be immensely lower than the costs of operating an insurance company (which collects capital for asset management purposes and passes on its higher operating costs to insured entities through premiums even if there is no valid claim by any of the insured entities).

(ii) Payment Collection and the Centralized System Operator's Fee

Payments may be deducted automatically via, for example, a credit card or PayPal account.

In example embodiments, the centralized system operator may charge users a certain percentage of the total claims to be paid out to cover costs of operating the platform. Alternatively, the central system operator may charge (i) a (small) one-off subscription fee or (ii) a (small) monthly contribution to cover some or all of the costs related to operating the platform. In certain versions, the monthly fee may not be charged (or may be lower) if there are no claims. In various embodiments, the fee charged may vary, and/or may be dynamically determined based on, for example, another metric corresponding to/correlated with the actual costs incurred (such as the number of claims processed).

(iii) Claim Processing

In various embodiments, if a user has a valid claim, the system operator collects contributions from users to settle the valid claims.

Once the contributions are received (or, e.g., a certain minimum percentage of contributions are received, and/or a certain minimum monetary amount has been received), the claim may be disbursed to the user who filed the claim. Optionally, in certain implementations, funds may be disbursed for valid claims before contributions have been collected.

This patent application describes example systems and techniques for offering, pricing and delivering no premium insurance/loss coverage via a centralized system operator. In various embodiments, the system/approach may involve, for example:

(i) displaying for a user (a potential insured entity), using a computing device, insurance product information for available policies/coverage plans,

(ii) receiving, at a centralized system, a request from the user for a quote, which may be cap-based, and determining the cap-based quote based on, for example, the user's risk profile (which may be generated based on responses to questions answered by the user) and/or based on the pool of other entities already insured (the pool including all entities, or a subset thereof based on, e.g., same types of loss covered, similar risk profiles, etc.);

(iii) displaying the cap-based quote/estimate for the policies/plans,

(iv) collecting information on the preferred payment method and payment details (such as account numbers) for the user, and

(iv) providing coverage/issuing a coverage policy for the user, all through a digital, computerized network.

This patent application also describes example systems and techniques for managing no premium insurances by the centralized system operator, including:
(i) receiving information on claims from insured entities and handling of claims (e.g., determining validity of claims based on information received and certain criteria);
(ii) determining the actual amount to be contributed by users (i.e., all insured entities, or insured entities in a relevant pool of insured entities) in the current time period (e.g., month) by, e.g., dividing the amount to be paid to all users with a valid claim in the current time period by the number of insured entities sharing the risk for the claimed losses),
(iii) transmitting payment requests to the payment service providers (e.g., financial institutions/banks/issuers of credit cards, PayPal, etc.) selected by each of the insured entities (“insureds”), and
(iv) providing compensation to users with valid claims once payments have been received (i.e., once payment requests have been honored by the payment service providers),
   all through a digital, computerized network.

All or part of the systems and techniques described herein may be implemented as a computer program product that includes instructions that are stored on one or more non-transitory machine-readable storage media, and that are executable on one or more processing devices. All or part of the systems and techniques described herein may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a block diagram that shows an exemplary system for offering, pricing and delivering no premium insurances by a central system operator.

FIGS. 2 through 7 collectively show an exemplary system and sequence of events for offering, pricing and delivering no premium insurances by a central system operator.

FIG. 8 is a block diagram that shows an exemplary system for managing no premium insurances by the central system operator.

FIGS. 9 through 13 collectively show an exemplary system and sequence of events for managing no premium insurances by the central system operator.

FIGS. 14 and 15 collectively show an exemplary user interface for no premium insurance and the filing of a claim.

FIG. 16 shows exemplary computer devices that could be used in implementing exemplary versions of the invention.

FIGS. 17 through 19 show exemplary flowcharts, from the perspective of the central system operator, on how a user takes out insurance, cancels an insurance, files a claim and pays a contribution.

FIG. 20 shows an exemplary automated process to determine the cap-based quotes.

FIGS. 21 through 23 show examples of exemplary uncertainty loading with various numbers of participants (25, 100 and 1000 participants).

FIG. 24 shows an exemplary automated monthly collection of contributions and payment of claim amounts.

FIG. 25 shows exemplary automated product lifecycle controls.

FIG. 26 shows exemplary automated risk controls.

FIG. 27 shows exemplary automated claims and cost controls.

FIG. 28 shows exemplary automated performance controls.

### DETAILED DISCUSSION

Discussed herein are example systems and methods for offering, pricing and delivering no premium insurances by a central system operator, as well as for managing no premium insurances by the central system operator. The insurance products may include life and non-life insurances, and can be as diverse as (for example) smartphone (or other belongings) insurance, term life insurance, travel insurance, liability insurance, etc. There may also be insurance products in relation to financials risks, such as interest rate risks and currency risks, or in relation to other types of risks, both current and future.

The system may be made accessible for anybody with an internet connection through a web application, or via another portal that is networked or otherwise capable of communicating with other computers.

The system presents to users one or more insurance products, and requests users to fill out an interactive form in relation to the insurance to be taken out. The system then produces a cap-based quote based on various variables, which is the maximum monthly amount the system can automatically deduct from the user's account to settle potential damages in the group of users. If a user agrees with the terms and conditions of the insurance and the cap-based quote, the user is from that moment covered. The first time a user takes out an insurance, the user is required to indicate the preferred payment method and provide payment details.

User with a valid claim can file this claim through the web application. If one or more users have filed a valid claim in a particular month, the system automatically calculates the total claim amount for this month and determines per user the exact amount to be deducted from a user's account. The amount to be paid can never be more than the cap-based quote. The system generates a payment request to users and transmits the payment request to the payment service provider selected by each of the users. After collecting the amounts, the system then provides compensation to the user with a valid claim.

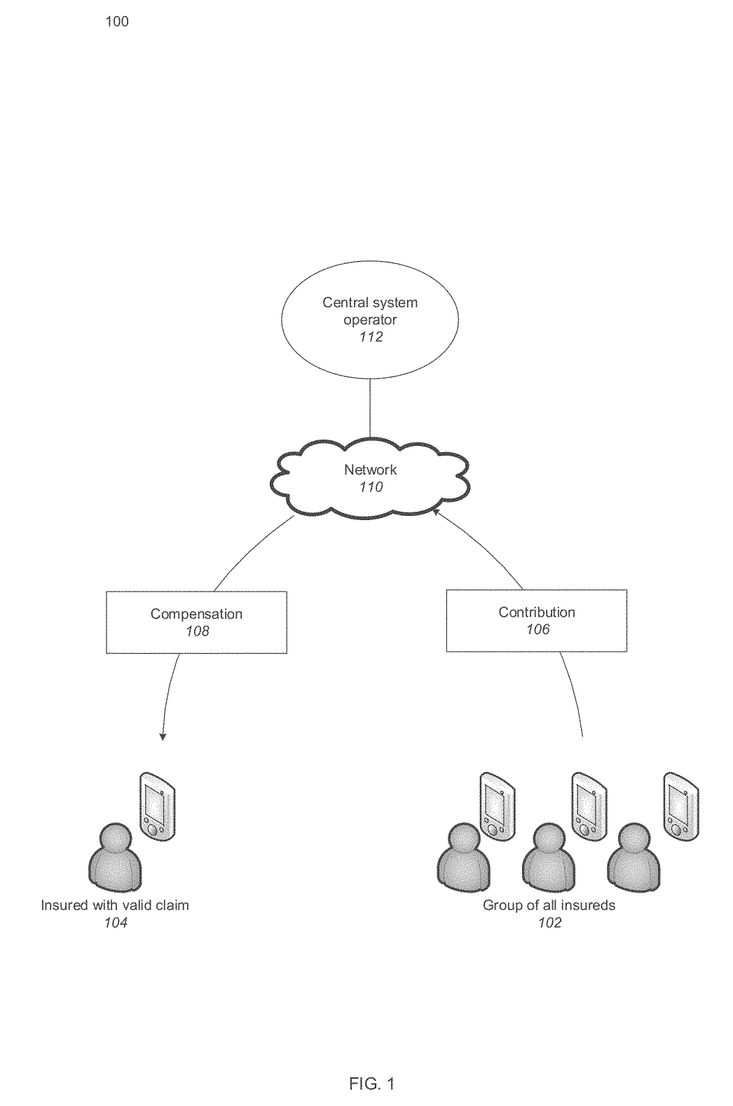

FIG. 1 is a block diagram that shows an example system 100 for no premium insurance. Using the system 100, for example, the group of all insureds 102 contribute an amount 106 to the central system operator 112, while the insured with a valid claim 104 claim receives compensation 108 from the central system operator 112 as compensation for damages. The system 100 can include one or more computer systems with which the central system operator 112 and insureds can communicate and complete the payment. For example, the insureds can use a personal computer, a laptop, or a smartphone or other mobile computing device.

In the example shown in FIG. 1, the group of all insureds 102 are contributors who are paying a contribution 106 to the central system operator 112 for the benefit of the insured with a valid claim 104. The group of all insureds 102 and the insured with a valid claim 104 do not interact directly with each other, only with the cloud-based central system operator. In this example, the system has determined per insured the exact amount to be paid to the central system operator for the benefit of the insured with a valid claim 104. The amount per user differs and is derived from the cap-based quote.

A. Offering, Pricing and Delivering No Premium Insurances

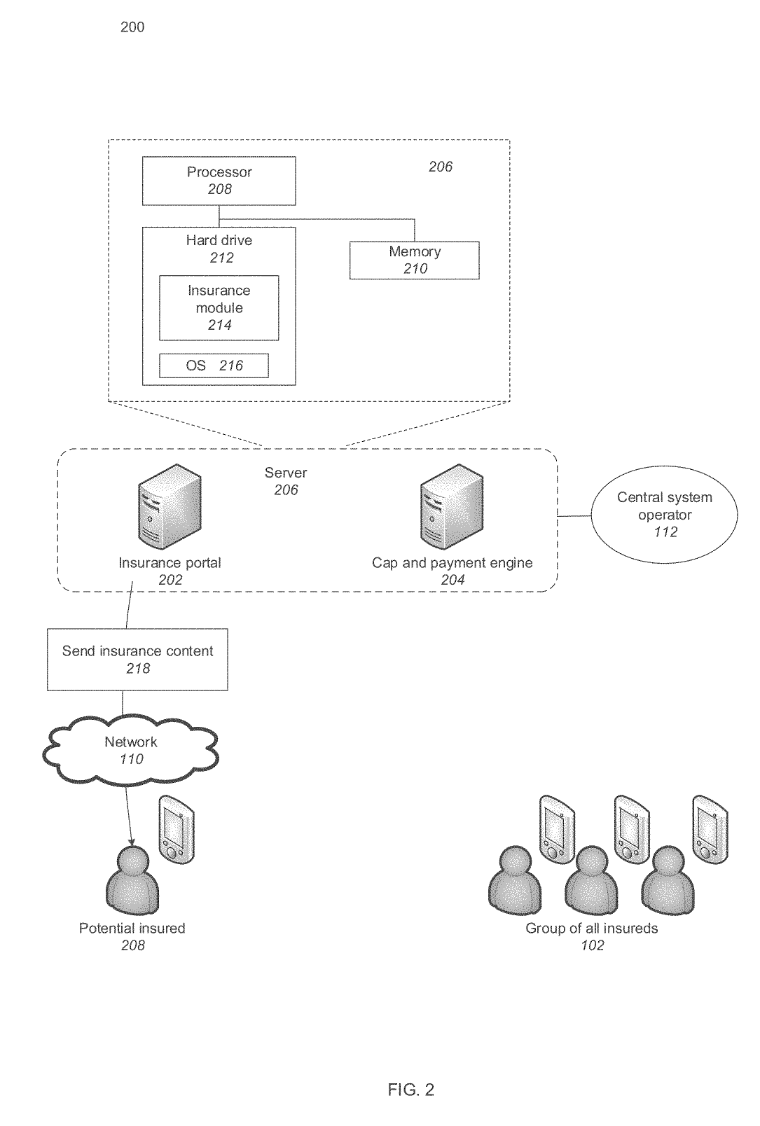

FIGS. 2 through 7 collectively show an example system 200 and sequence of events for offering, pricing and delivering no premium insurances by a central system operator.

Referring to FIG. 2, the system 200 includes at least:
(i) one insurance portal 202 for serving insurance content from the system;
(ii) at least one cap and payment engine (“CPE”) 204 for computing (a) the cap-based quote for users who want to take out an insurance and (b) the amount to be paid by the group of all insureds 102 to the central system operator for the benefit of an insured with a valid claim 104; and
(iii) at least one server 206 which includes at least the insurance portal 202 and the CPE 204.

The network 110 can connect the insurance portal 202, the CPE 204 and the server 202 with any number of users.

For example, the insurance portal 202 operates as a data and communication engine for several insurances designed by the central system operator, and serves content to online users such as the potential insured 208. Example insurances can include phone insurance, bike insurance, travel insurance, and so on. The insurance portal 202 can interact with the CPE 204 as well as other databases and other servers, either on the server 206 or connected using the network 110, each of which can host a separate web site. Users such as a potential insureds 208 and the group of all insureds 102 can interact with the web sites, using the network 110, to review insurances (e.g., insurance content 218), to select and take out insurance.

In some implementations, the insurance portal 202, the CPE 204 and the server 206 include a processor 208 communicatively coupled to memory 210 and a hard drive 212. The processor 208 can process instructions (e.g., stored in the memory 210) for execution within the insurance portal 202 and the CPE 204. The hard drive 212 can store data instructions for an insurance module 214 for providing insurance content to users, and an operating system 216 for executing applications on the insurance server 202.

The insurance module 214, for example, can include applications that serve insurance content for viewing. For example, the insurance module 214 can be the component of the insurance portal 202 that primarily provides the insurance content 218 (e.g., part or all of an insurance policy, etc.) to the potential insured 208 or the group of all insureds 102.

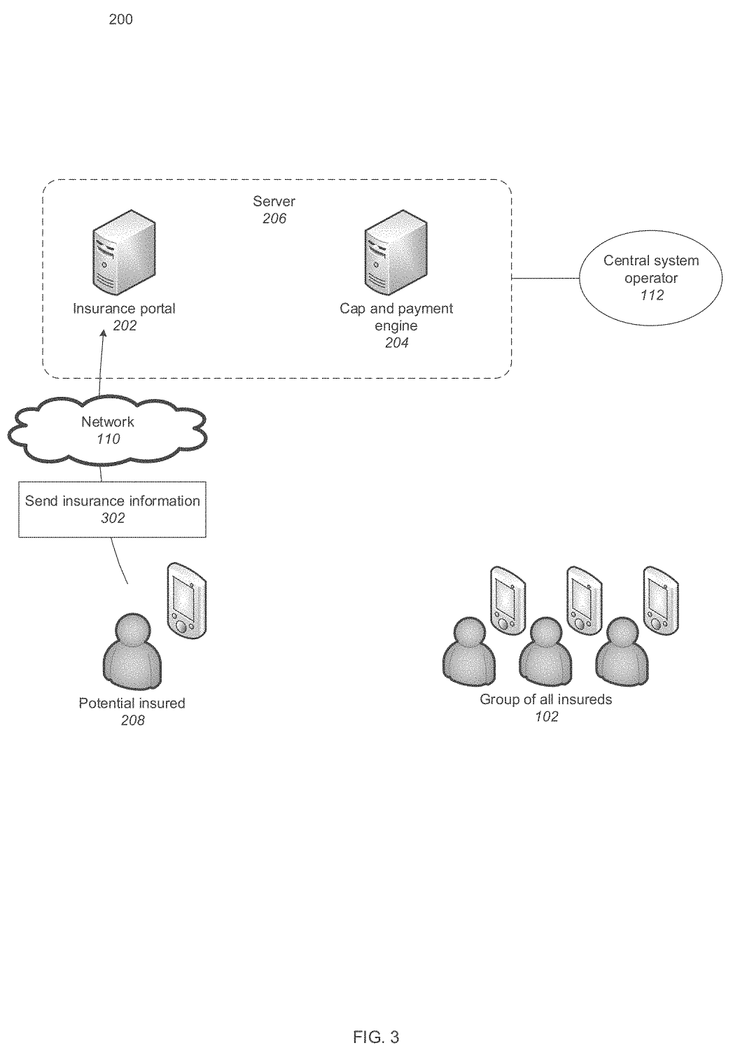

For example, the act of the potential insured 208 receiving the insurance content 218 from the insurance portal 202 can be the first in a sequence of events for no premium insurance. The remaining actions, for example, are shown in FIGS. 3-7.

The information is submitted to the insurance portal 202. For example, referring to FIG. 3, the potential insured 208 can provide insurance information 302 to the insurance portal 202. The type of insurance information is dependent on the risk against which the user wishes to insure. Examples of insurance information 302 can be the listing price of a product. The insurance portal 202 receives the insurance information 302 over the Internet through a secure network connection. The insurance information 302 can be stored on the insurance server 202, server 206 or otherwise, dependent on the fact whether the potential insured 208 proceeds with taking out an insurance, thus becoming an insured.

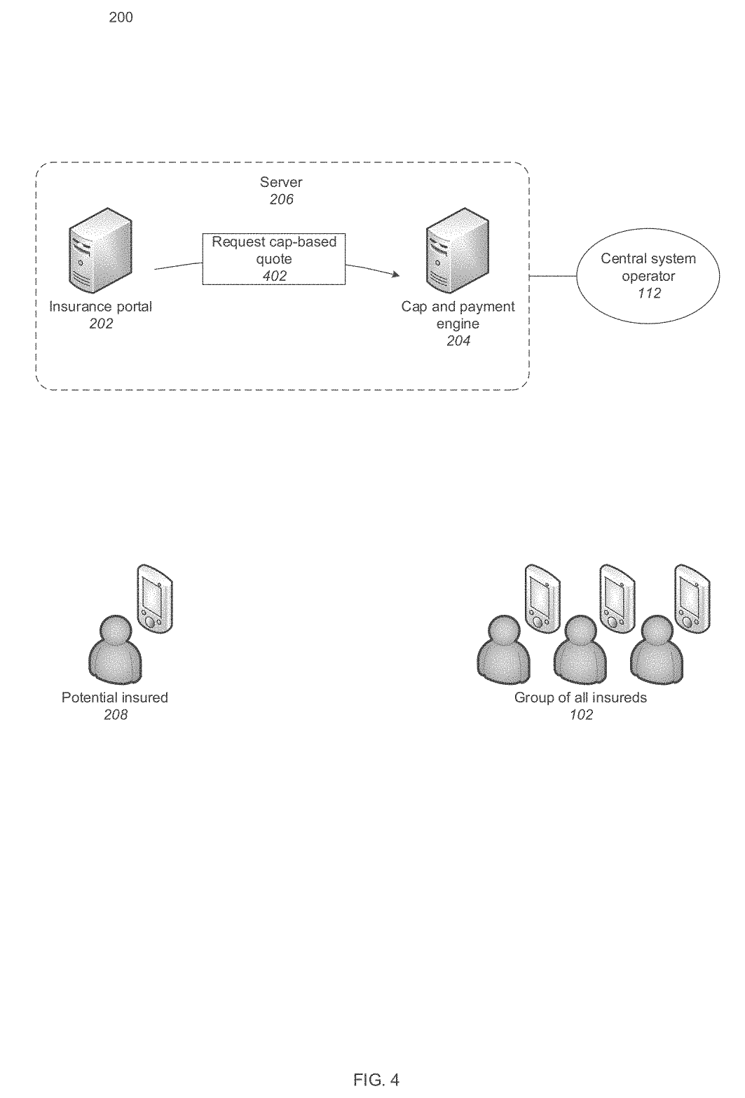

If the insurance portal 202 has received the insurance information 302, the insurance portal 202 requests a cap-based quote 402 for the insurance product from the CPE 204. As an example, referring to FIG. 4, the insurance portal 202 can provide a request 402 to the CPE 204 for the cap-based quote, by providing the information received from the potential insured 208. The request can be in the form of supplying any combination of location information, including country, zip code, purchase date, initial purchase price, listing price, etc. Any pieces of information supplied with the request can be used to determine the cap-based quote associated with the insurance product and the insurance information 302 provided by the potential insured 208.

In some implementations, the insurance portal 202, the CPE 204 and/or the server 206 can maintain a cache of product details and cap-based quotes in order to make the process more efficient. In this case, the insurance server 202, the CPE 204 and/or server 206 can send (or be requested to send) periodic updates to each other within the network in order to keep the information up-to-date.

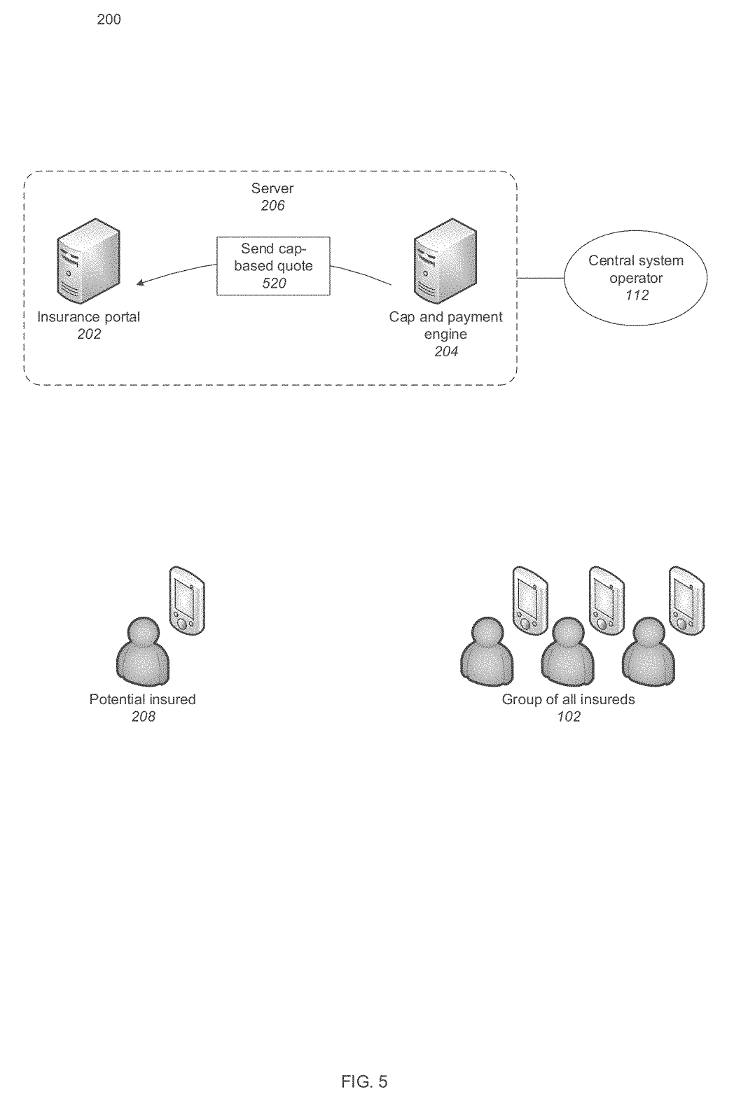

The cap-based quote is sent to the insurance portal 202, by the CPE 204. For example, referring to FIG. 5, the CPE 204 calculates and provides a cap-based quote 502 to the insurance portal 202, such as over the network 110. The cap-based quote is received by the insurance portal 202.

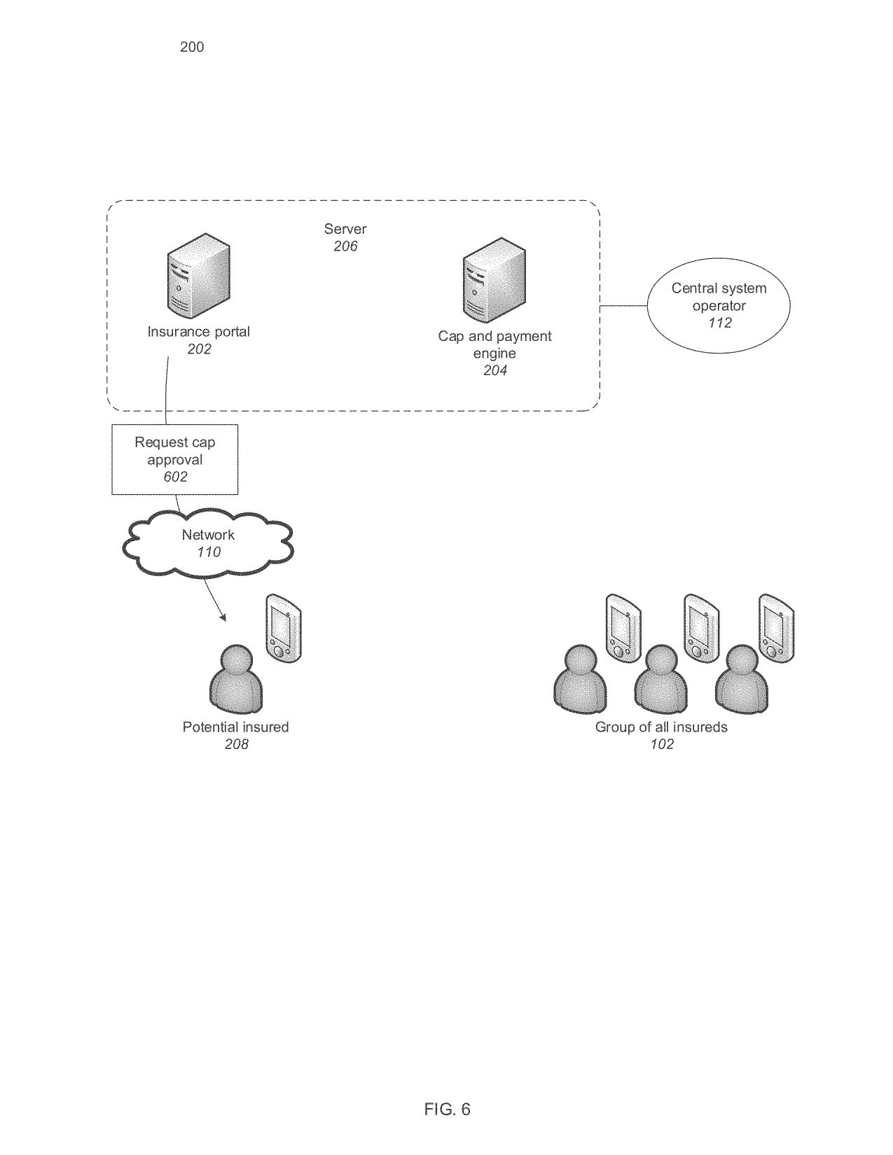

Approval of the cap-based quote is requested by the insurance portal 202 to the potential insured 208. As an example, referring to FIG. 6, the insurance portal 202 can request cap approval 602 from the potential insured 208. In some implementations, the request may include an option to enter a promotional code for a temporary discount. That option may be declined, in which case the recipient may receive the regular cap-based quote.

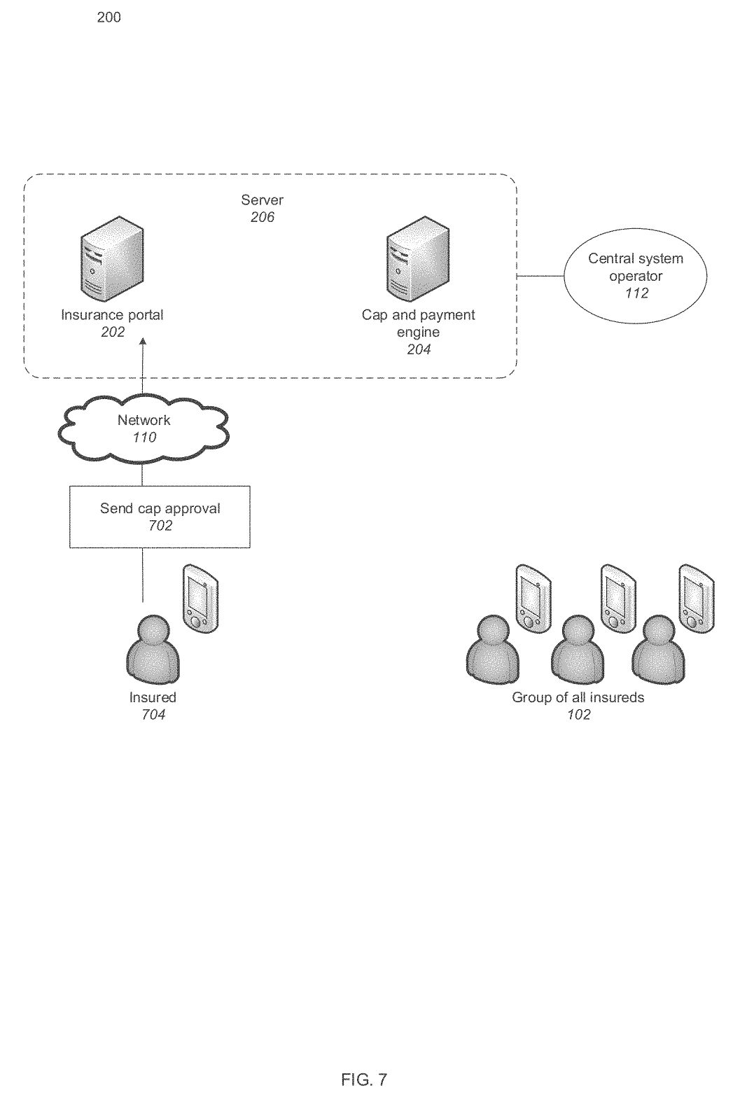

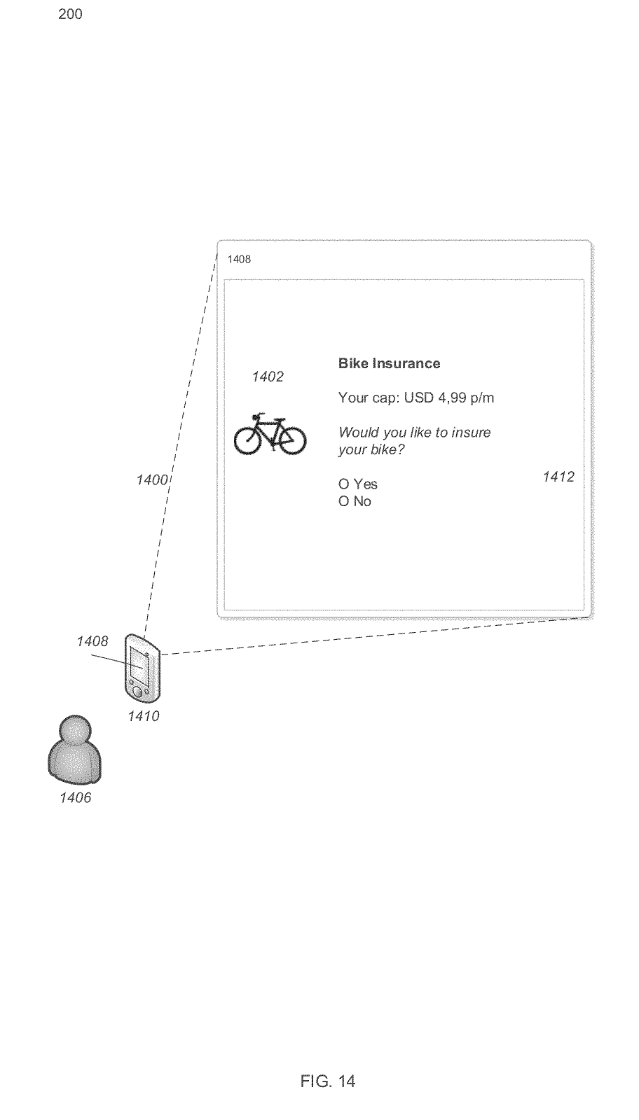

The cap-based quote can be approved by the potential insured 208. The interface of the approval menu is described in FIG. 14. The potential insured 208 reviews the insurance product and the cap to which he or she is about to agree. By pressing on yes, the potential insured becomes an insured 704. For example, referring to FIG. 7, the potential insured 208 can send a cap approval 702 to the insurance portal 202.

The first time a potential insured 208 takes out an insurance, the user is required to indicate the preferred payment method and provide payment details.

In some implementations, sending payment details to the insurance portal 202 can involve one or more intermediate parties, such as online payment systems that debit an account of an insured 704 and credit an account of the payment service provider of the central system operator 112. In some implementations, payment may be delayed for a short time (e.g., minutes to hours) in order for the payment to be authenticated or approved and to post to various accounts.

Payment authentication is received, e.g., by the third party secure payment module integrated with the network 110. For example, referring to FIG. 7, the insurance portal 202, the CPE 204 and/or the server 206 can receive a payment authentication confirmation over the network 110, or in a network path that includes the network 110 and one or more intermediate parties.

B. Managing No Premium Insurances

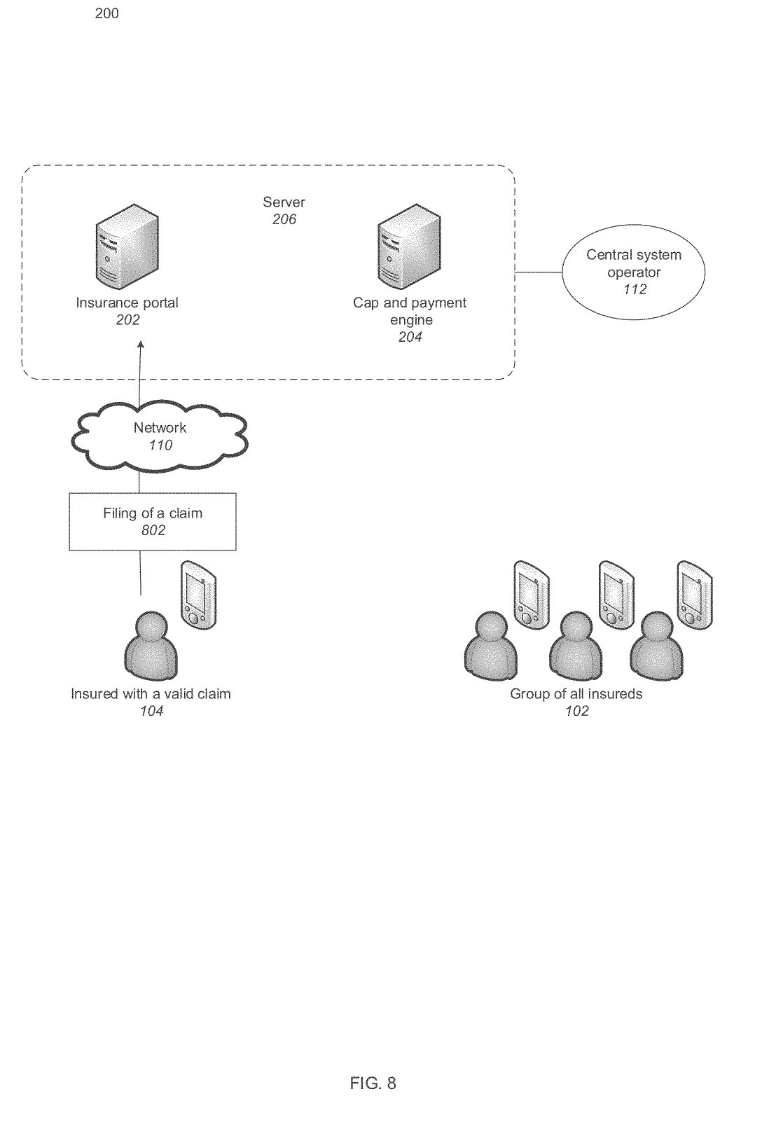

FIGS. 8 through 13 collectively show an example system 200 and sequence of events for managing no premium insurances by the central system operator.

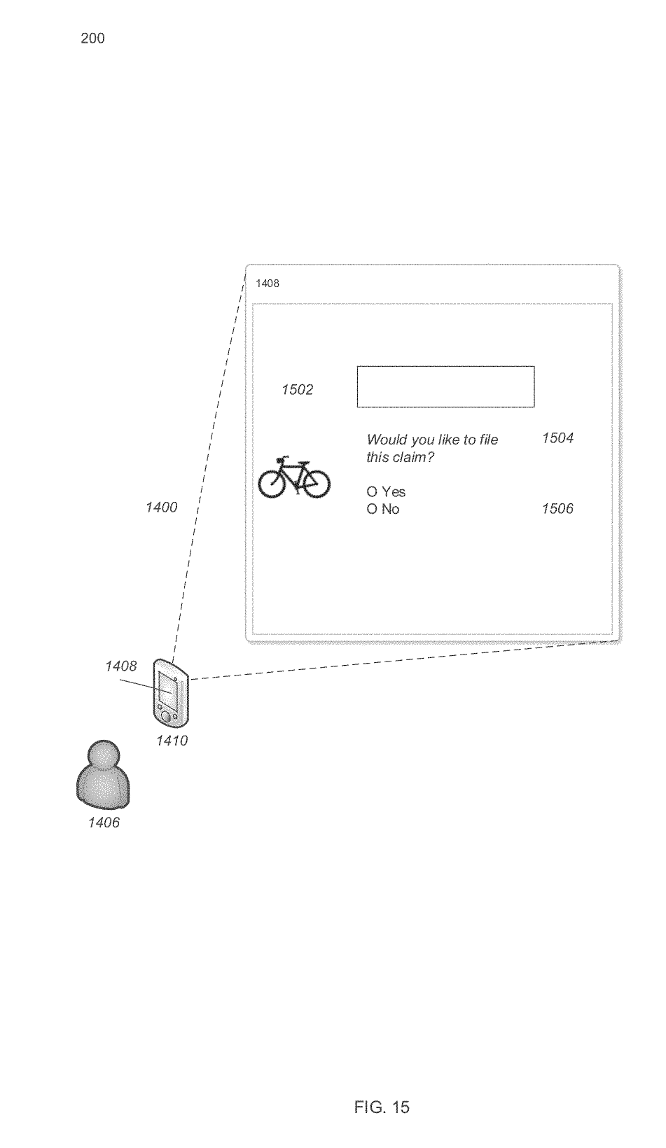

When an insured 704 incurs damages, the insured can file a claim in a particular menu of the web application. The interface of the claim menu is described in FIG. 15.

The insured 704 is also asked to upload certain files. When files are submitted, the webserver generates a web link and a unique token, which are transmitted back to the front-end. After that, the uploaded document and the token combined with a digital authentication handshake are sent back to the cloud server, were a token is generated. The user only sees a confirmation of submittal. After the procedure, the claim and the associated files are ready to be reviewed and validated by the central system operator.

As an example, referring to FIG. 8, an insured with a valid claim 104 files a claim 802 to the central system operator by sending the claim to the insurance portal 202.

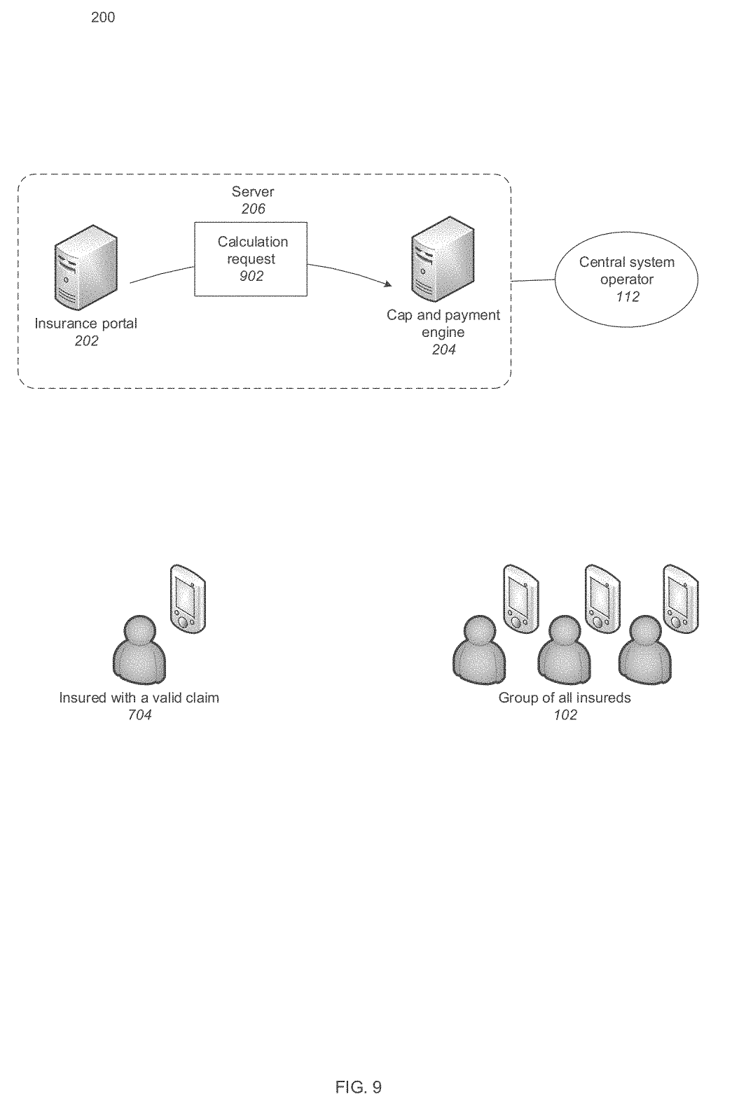

Then from the insurance server 202 a calculation request 902 is submitted to the CPE 204 within the secure network 110 as displayed in FIG. 9. If one or more users have filed a valid claim in a particular month, the system calculates the total claim amount for this month and determines per user the exact amount to be deducted from a user's account. The amount to be paid is between zero and the cap-based quote to which the particular user has agreed. The amount to be paid can never be more than the cap-based quote.

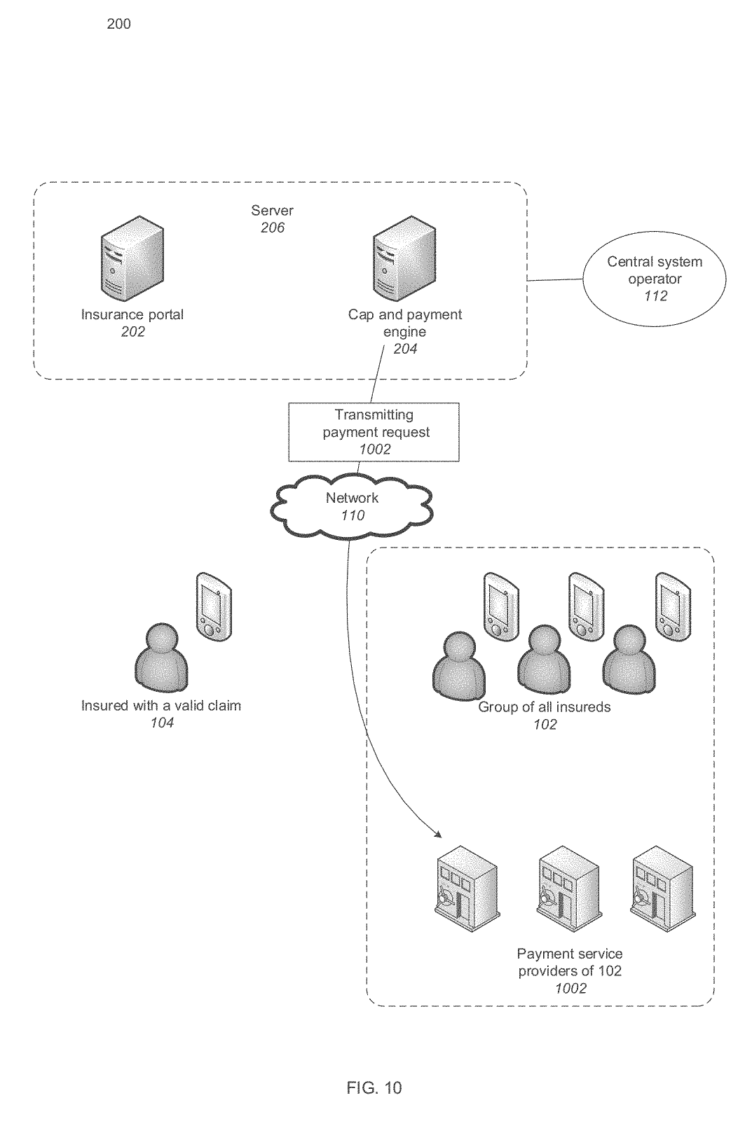

Then from the CPE 204 a payment request will be generated and transmitted to the payment service providers of the insureds. As an example, referring to FIG. 10, the CPE 204 generates and transmits a payment request to the payment service providers of the insureds 1002.

In some implementations, to collect the contributions, the content server can automatically access account information that has been pre-established for each insured that is part of the group of all insureds 102, and automatically charge the account of each insured that is part of the group of all insureds 102 up to the individual cap-based quote.

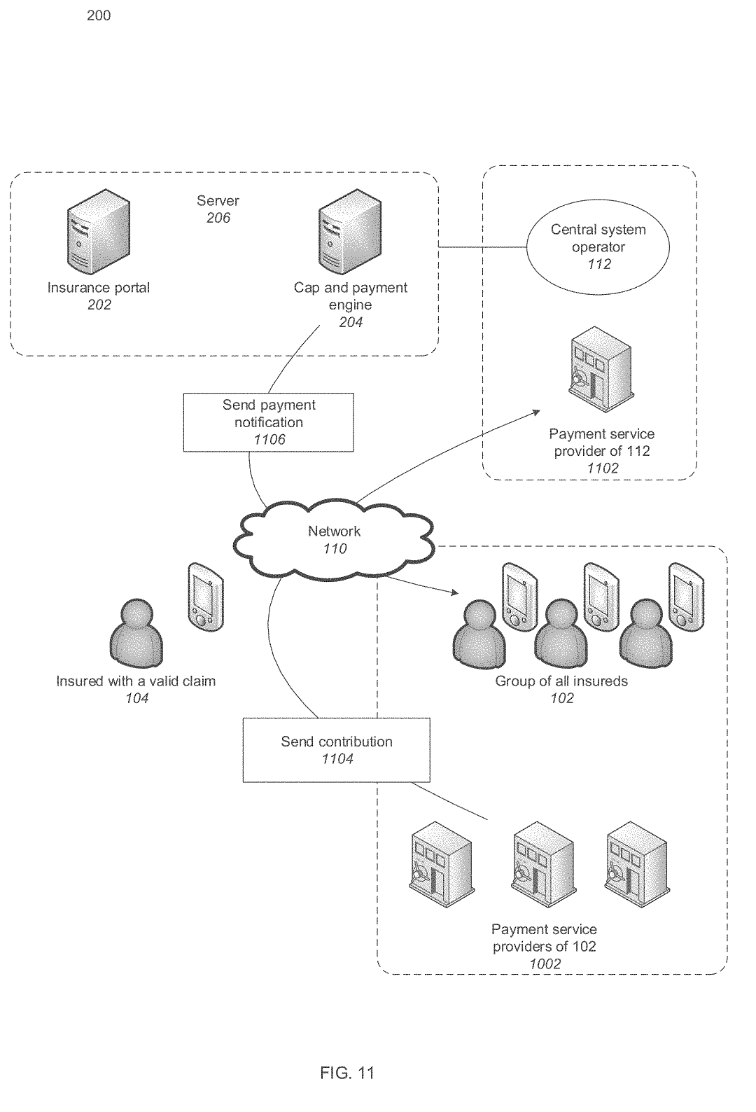

FIG. 11 displays the payment collection from the payment service providers of the insureds 1002. The payment service providers send a contribution 1104 to the payment service provider of the central system operator 1102. Insureds will be notified by the CPE 204 immediately after the collection through a payment notification 1106. The payment notification states the contribution, the method of payment and the fee collected by the central system operator 112. Collection of amounts is performed shortly after the end of the month.

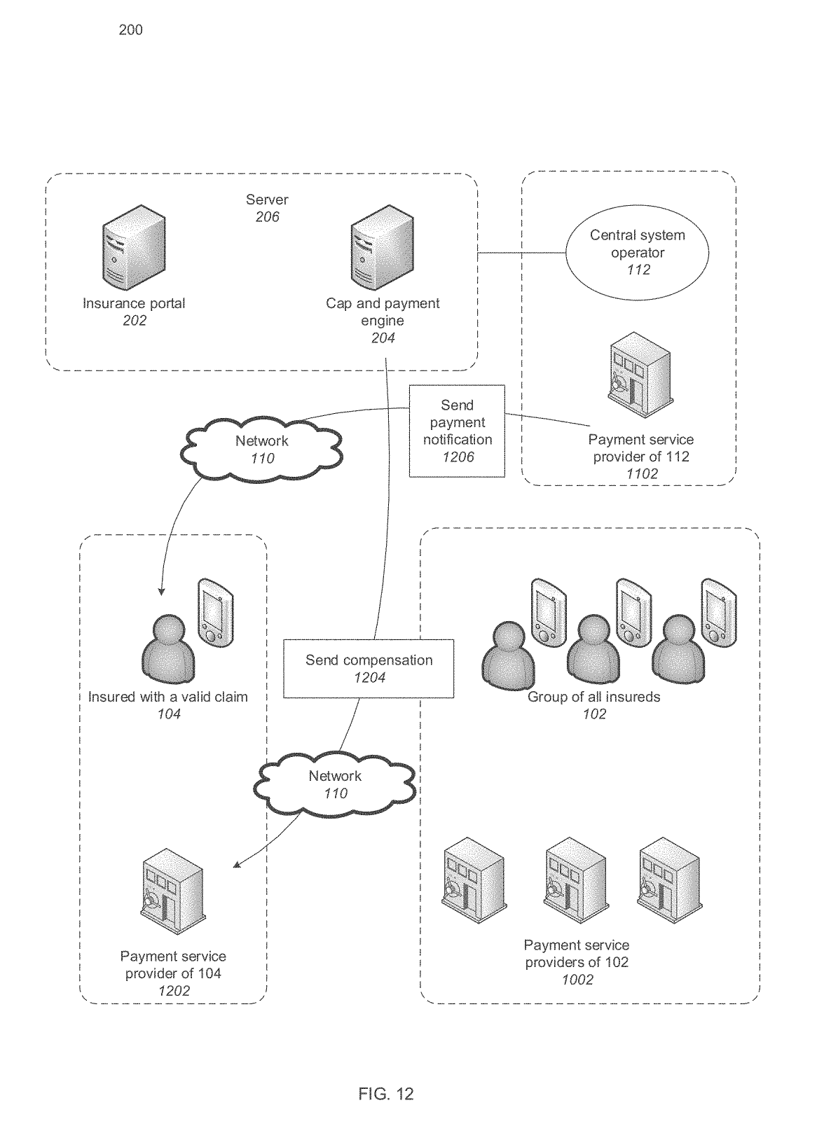

The central system operator 112 will initiate payment of the valid claim to the insured with a valid claim 104 shortly after the end of the month in which the claim was validated by the central system operator 112. FIG. 12 displays the sending of the compensation 1204 by the payment service provider of the central system operator 1102 to the payment service provider of the insured with a valid claim 1202. The CPE 204 will send a payment notification 1206 to the insured with a valid claim 104. By receiving the compensation, the insured with a valid claim 104 becomes an insured 704 again.

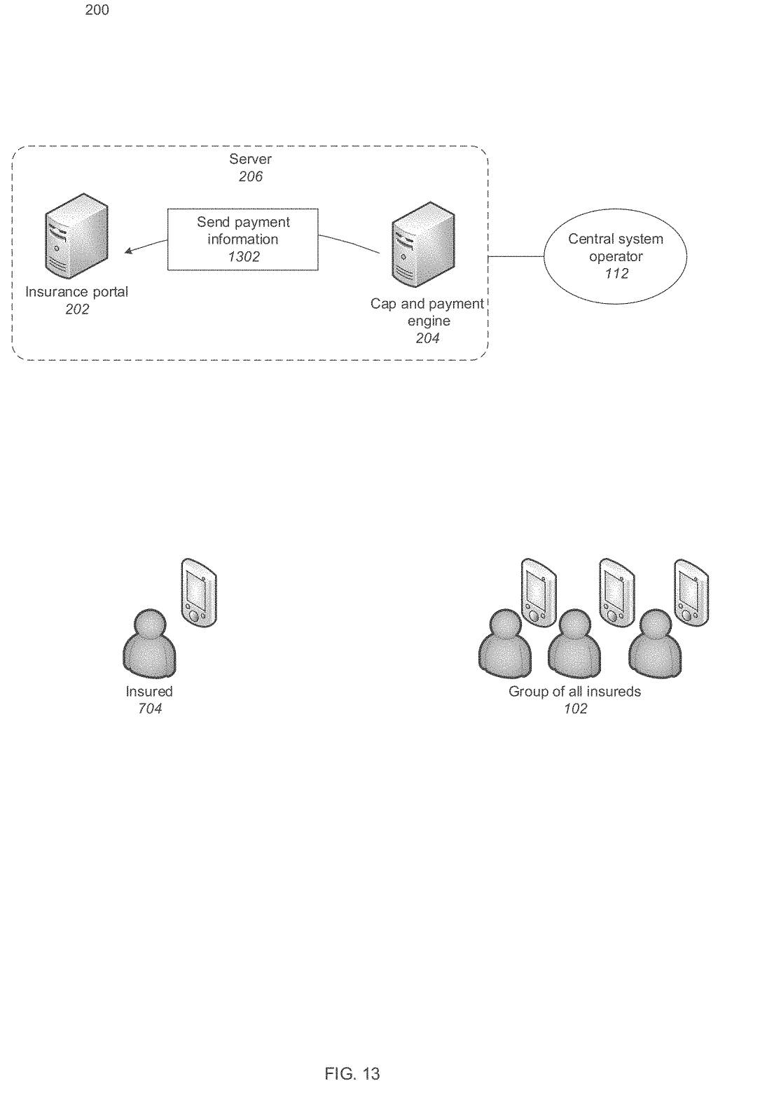

The insurance server 202 and the CPE 204 will send (or be requested to send) periodic updates to each other within the server and network in order to keep the information up-to-date. For example, referring to FIG. 13, the CPE 204 will send information on the payments received from the group of all insureds 102 and the payment to the insured with a valid claim 104 by the central system operator 112.

FIGS. 14 and 15 collectively show an example user interface 1400 for taking out no premium insurance and for filing a claim. For example, the user interface 1400 can display insurance products that can be taken out (e.g., a bike insurance 1402) or guide the user through the claim process (e.g., filing a claim 1502). A user 1406 may be taking out the insurance or file a claim at any moment on its computer device. For example, the user 1406 may take out the insurance 1402 or file a claims 1504 and 1506 through a screen 1408 of a computer device 1410, such as a laptop, personal computer, smartphone or other mobile computing device.

FIG. 14 shows an example user interface 1400 for taking out no premium insurance. The user interface will be available when accessing the web application. For example, the user interface 1408 will display insurance products that can be taken out. Upon filling out the requested information, e.g. for bike insurance, the potential insured 208 will receive a cap-based quote for taking out the insurance. The cap-based quote can be approved by the potential insured 208. The potential insured 208 sees the insurance product and the cap to which he or she is about to agree. By pressing on yes 1412, the potential insured becomes an insured 704. The user will then receive a confirmation of insurance in its account and by e-mail.

FIG. 15 shows an example user interface 1400 for filing a claim. The interface consists of an information entry area 1502 for providing details on the incident having caused the loss and the amount of damages. The information entry area 1502 may include fields for uploading various types of information documents, including, for example, photographic evidence of the damages and proof of ownership. By pressing on yes 1506, the insured submits the claim to the central system operator. The user will have access to the claim screen 1502 when the user is logged in to the web application and enters the menu for submitting claims.

C. Exemplary Example of Generic (Mobile) Computer Devices

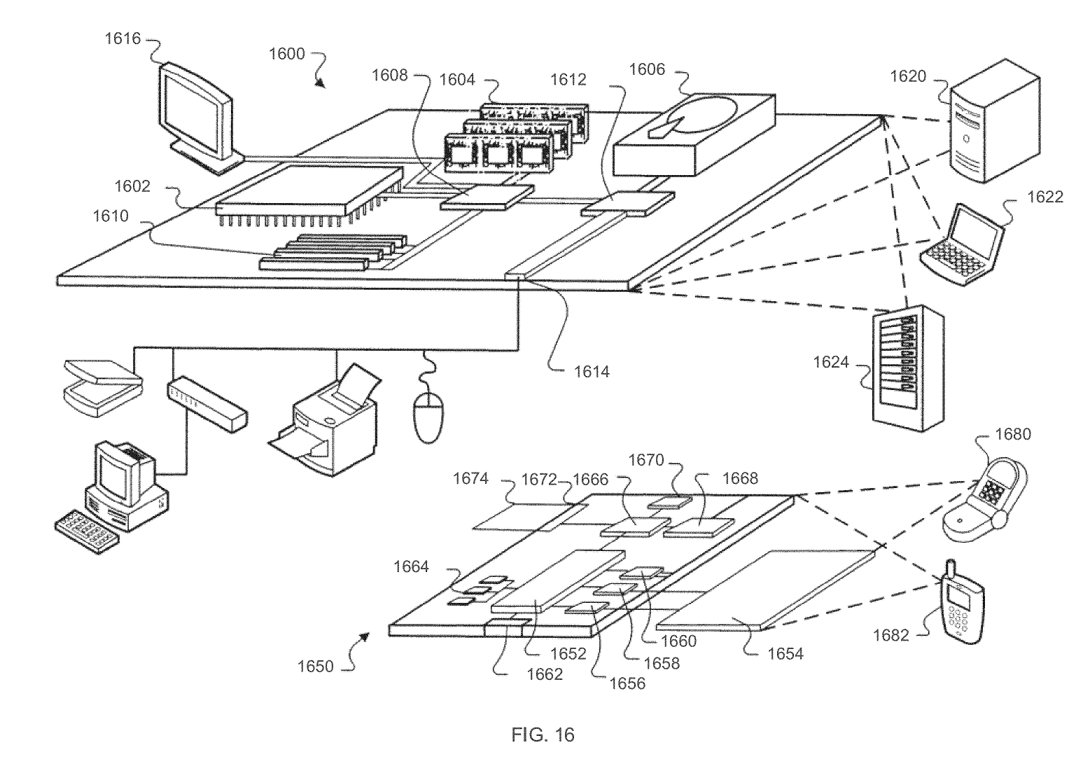

FIG. 16 shows an example of a generic computer device 1600 and a generic mobile computer device 1650, which may be used to implement the processes described herein, including the mobile-side and server-side processes for installing a computer program from a mobile device to a computer. Computing device 1600 is intended to represent various forms of digital computers, such as laptops, desktops, workstations, personal digital assistants, servers, blade servers, mainframes, and other appropriate computers. Computing device 1650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 1600 includes a processor 1602, memory 1606, a storage device 1606, a high-speed interface 1608 connecting to memory 1604 and high-speed expansion ports 1610, and a low speed interface 1612 connecting to low speed bus 1616 and storage device 1606. Each of the components 1602, 1604, 1606, 1608, 1610, and 1612 are interconnected using various busses, and may be mounted on a common motherboard or in other manners as appropriate. The processor 1602 can process instructions for execution within the computing device 1600, including instructions stored in the memory 1606 or on the storage device 1606 to display graphical information for a GUI on an external input/output device, such as display 1616 coupled to high speed interface 1608. In other implementations, multiple processors and/or multiple busses may be used, as appropriate, along with multiple memories and types of memory. Also, multiple computing devices 1600 may be connected, with each device providing portions of the necessary operations (e.g., as a server bank, a group of blade servers, or a multi-processor system).

The memory 1604 stores information within the computing device 1600. In one implementation, the memory 1604 is a volatile memory unit or units. In another implementation, the memory 1604 is a non-volatile memory unit or units. The memory 1604 may also be another form of computer-readable medium, such as a magnetic or optical disk.

The storage device 1606 is capable of providing mass storage for the computing device 1400. In one implementation, the storage device 1606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 1604, the storage device 1606, or memory on processor 1602.

The high speed controller 1608 manages bandwidth-intensive operations for the computing device 1600, while the low speed controller 1612 manages lower bandwidth-intensive operations. Such allocation of functions is exemplary only. In one implementation, the high-speed controller 1608 is coupled to memory 1604, display 1616 (e.g., through a graphics processor or accelerator), and to high-speed expansion ports 1610, which may accept various expansion cards (not shown). In the implementation, low-speed controller 1612 is coupled to storage device 1606 and low-speed expansion port 1614. The low-speed expansion port 1614, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1600 may be implemented in a number of different forms, as shown in the figure. For example, it may be implemented as a standard server 1620, or multiple times in a group of such servers. It may also be implemented as part of a rack server system 1624. In addition, it may be implemented in a personal computer such as a laptop computer 1622. Alternatively, components from computing device 1600 may be combined with other components in a mobile device (not shown), such as device 1650. Each of such devices may contain one or more of computing device 1600, 1650, and an entire system may be made up of multiple computing devices 1600, 1650 communicating with each other.

Computing device 1650 includes a processor 1652, memory 1664, an input/output device such as a display 1654, a communication interface 1666, and a transceiver 1668, among other components. The device 1650 may also be provided with a storage device, such as a microdrive or other device, to provide additional storage. Each of the components 1650, 1652, 1664, 1654, 1666, and 1668 are interconnected using various busses, and several of the components may be mounted on a common motherboard or in other manners as appropriate.

The processor 1652 can execute instructions within the computing device 1650, including instructions stored in the memory 1664. The processor may be implemented as a chipset of chips that include separate and multiple analog and digital processors. The processor may provide, for example, for coordination of the other components of the device 1650, such as control of user interfaces, applications run by device 1650, and wireless communication by device 1650.

Processor 1652 may communicate with a user through control interface 1658 and display interface 1656 coupled to a display 1654. The display 1654 may be, for example, a TFT LCD (Thin-Film-Transistor Liquid Crystal Display) or an OLED (Organic Light Emitting Diode) display, or other appropriate display technology. The display interface 1656 may comprise appropriate circuitry for driving the display 1654 to present graphical and other information to a user. The control interface 1658 may receive commands from a user and convert them for submission to the processor 1652. In addition, an external interface 1662 may be provided in communication with processor 1652, so as to enable near area communication of device 1650 with other devices. External interface 1662 may provide, for example, for wired communication in some implementations, or for wireless communication in other implementations, and multiple interfaces may also be used.

The memory 1664 stores information within the computing device 1650. The memory 1664 can be implemented as one or more of a computer-readable medium or media, a volatile memory unit or units, or a non-volatile memory unit or units. Expansion memory 1674 may also be provided and connected to device 1650 through expansion interface 1672, which may include, for example, a SIMM (Single In Line Memory Module) card interface. Such expansion memory 1674 may provide extra storage space for device 1650, or may also store applications or other information for device 1650. Specifically, expansion memory 1674 may include instructions to carry out or supplement the processes described above, and may include secure information also. Thus, for example, expansion memory 1674 may be provide as a security module for device 1650, and may be programmed with instructions that permit secure use of device 1650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1664, expansion memory 1674, memory on processor 1652, or a propagated signal that may be received, for example, over transceiver 1668 or external interface 1662.

Device 1650 may communicate wirelessly through communication interface 1666, which may include digital signal processing circuitry where necessary. Communication interface 1666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1668. In addition, short-range communication may occur, such as using a Bluetooth, Wi-Fi, or other such transceiver (not shown). In addition, GPS (Global Positioning System) receiver module 1670 may provide additional navigation- and location-related wireless data to device 1650, which may be used as appropriate by applications running on device 1650.

The computing device 1650 may be implemented in a number of different forms, as shown in the figure. For example, it may be implemented as a cellular telephone 1680. It may also be implemented as part of a smartphone 1682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

Other implementations not specifically described herein are also within the scope of the following claims.

### DETAILED DESCRIPTION OF EXEMPLARY IMPLEMENTATIONS

Discussed herein is exemplary technology that could be used to implement the no premium insurance and the exemplary system and method described in the section above.

First, several automated front-end processes are described, all from the perspective of the central system operator, including:
a. How a user takes out insurance;
b. How a user cancels an insurance; and
c. How a user files a claim.

Second, several automated back-end processes are described, including:
d. The automated process to determine the cap-based quotes;
e. The automated monthly collection of contributions and payment of claim amounts;
f. The automated product lifecycle controls;
g. The automated risk controls;
h. The automated performance controls; and
i. The automated cost controls.

A. How a User Takes Out Insurance

The technology platform organised by the central system operator enables users, through mobile applications or websites, to arrange insurance with each other. A user's insurance starts immediately after the user has accepted the cap-based quote and terms and conditions to the particular insurance.

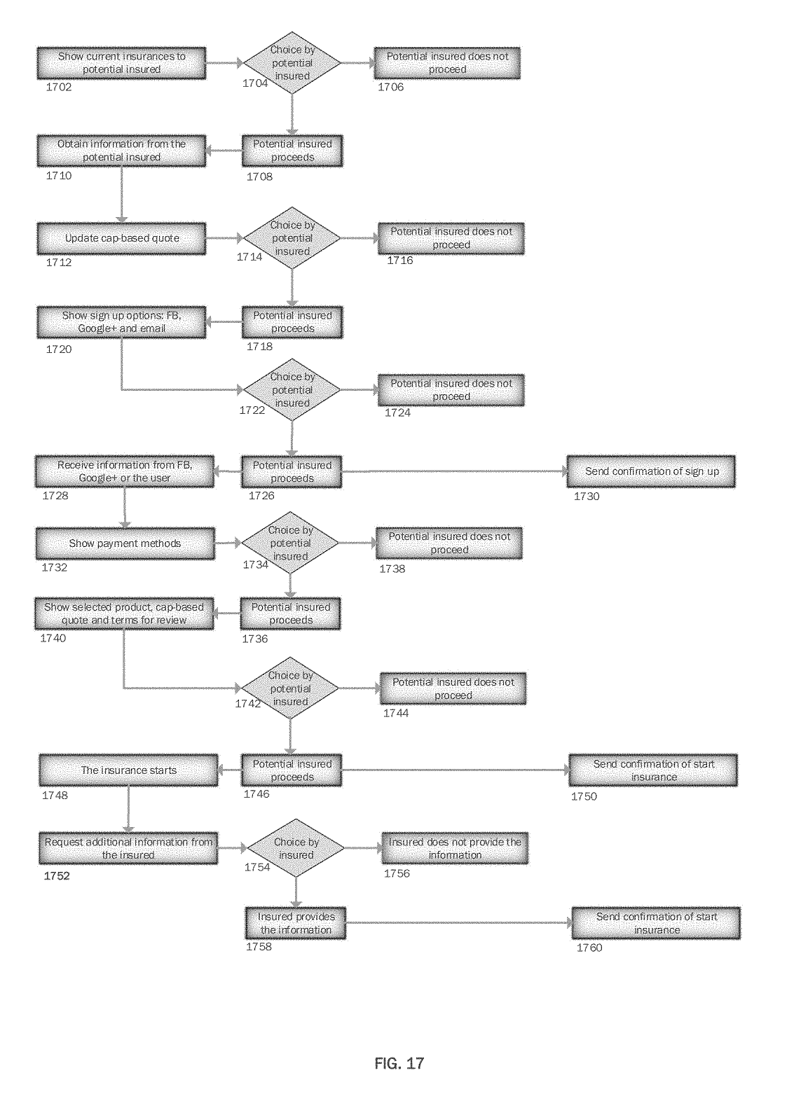

FIG. 17 shows a flowchart of how a potential insured takes out insurance from the perspective of the central system operator. The central system operator, through the server, shows current insurances to the potential insured (1702). This can, e.g., be phone, bike or travel insurance. The potential insured will then have to make a choice which insurance he or she wants to take out (1704). The potential insured can either decide to not proceed (1706) or proceed by choosing an insurance (1708). The central system operator, through the server, obtains information from the potential insured (1710). This can include, but is not limited to the type of product to be insured (e.g. an Apple iPhone SE), the list price of the product, the purchase date, the zip code, the type of coverage (e.g. US, Europe or world), additional coverage (e.g. extended warranty, wintersport and/or cancellation) and information relating to the potential insured (e.g. payment and claim history).

Based on the obtained information, the central system operator, through the server, will give an updated cap-based quote to the potential insured (1712). The potential insured will then have to make a choice whether he or she agrees with the cap-based quote (1714). The potential insured can either decide to not proceed (1716) or proceed (1718).

If the insured decides to proceed, he or she will be shown the sign up options, including but not limited to Facebook, Google+ and the creation of an acount based on an email address and password (1720). The potential insured will then have to make a choice which sign up method to use (1722). The potential insured can either decide to not proceed (1724) or proceed (1726). If a potential insured chooses to proceed and fill out the Facebook, Goole+ or account information, the central system operator, through the server, will receive information from Facebook, Google+ or the user (1728). The Central system operator, through the server, will send the potential insured a confirmation of the sign up (1730).

Subsequently, the central system operator, through the server, shows the payment methods, including but not limited to debit cards, credit cards, PayPal accounts, and iDEAL (1732). The potential insured will then have to make a choice which payment method to use (1734). The potential insured can either decide to not proceed (1738) or proceed (1736).

If the potential insured chooses a payment method, the central system operator will show the selected insurance product, the cap-based quote for this product based on the provided information by the potential insured, as well as the general terms and conditions and the product terms (1740). The potential insured will then have to review the information and decide whether to proceed (1742). The potential insured can either decide to not proceed (1744) or proceed (1746). If the potential insured proceeds (1746), the insurance starts from that moment onwards (1748) and the central system operator, through the server, will send the user a confirmation that the insurance product has been taken out (1750).

Subsequently, the central system operator will request additional information from the insured (1752), e.g. the EMEI code or photos of the insured phone. The potential insured will then have to make a choice to provide the information or not (1754). The potential insured can either decide to provide the information (1758) and receive a confirmation (1760), or to postpone the provision of the information (1756).

B. How a User Cancels an Insurance

The insurance will continue until the user cancels it. Alternatively, the central system operator can cancel the insurance without prior written notice if the user: (i) fails to pay the contribution after three attempts at payment collection or after 15 days from the payment instruction, whichever comes first; or (ii) makes a claim which the central system operator considers to be fraudulent. The cap and the terms and conditions are fixed for one (1) year. The central system operator may nevertheless amend the cap and/or terms and conditions by giving the user 14 days written notice in material adverse situations: significant adverse claims experience, significant increase in the system's operating costs, serious economic factors, and changes in legislation and taxation. The user can then cancel his or her insurance.

The insurance coverage will end automatically if the user no longer has an interest in his or her insurance, for example, if the user has sold his or her insured phone. The user is responsible for cancelling the insurance. The insurance coverage will also end automatically if the user moves to another country. The user is responsible for cancelling the insurance and taking out a new insurance based on the country to where he or she has moved.

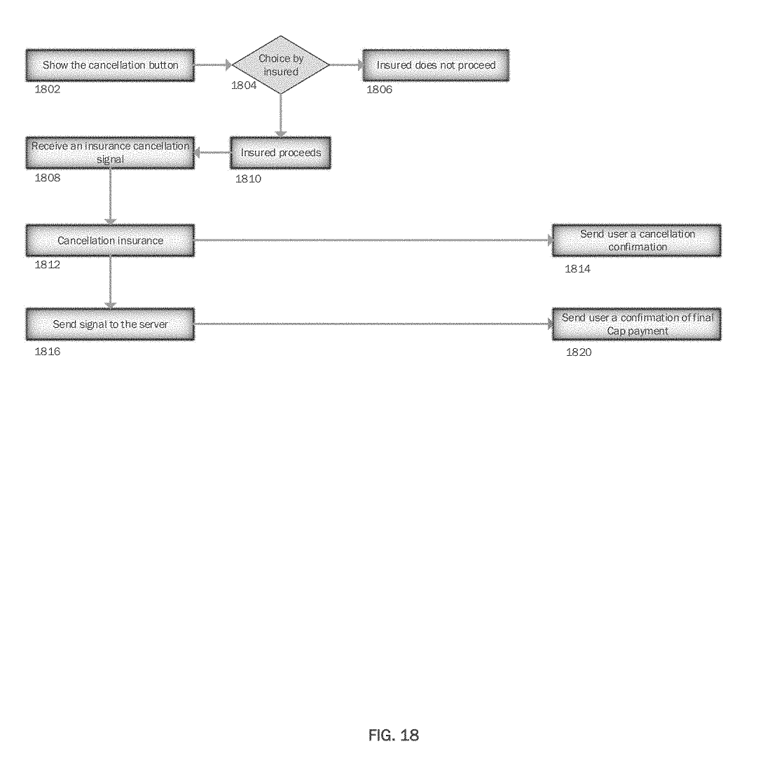

FIG. 18 shows a flowchart of how an insured cancels an insurance from the perspective of the central system operator. The central system operator, through the server, shows a cancellation button to the insured for each insurance the insured has taken out (1802). This can, e.g., be phone, bike or travel insurance. The potential insured will then have to decide whether he or she wants to cancel an insurance (1804). The insured can either decide to not proceed (1806) or proceed with cancelling an insurance (1808). If the insured proceeds (1808), the central system operator receives an insurance cancellation signal and the insurance ends from that moment onwards (1812). Subsequently, the central system operator, through the server, will send the user a confirmation that the insurance product has been cancelled (1814). A signal will automatically be sent to the server to collect the final cap payment from the insured for the cancelled insurance (1816). Subsequently, the user receives a confirmation of the final cap payment from the server (1818).

C. How a User Files a Claim

Each insured appoints the central system operator as the insured's agent for the purpose of handling claims from insureds with a claim on behalf of other insureds. Each insured agrees that payment made by the central system operator, through the server, to an insured with a valid claim, shall be considered the same as a payment made directly by an insured, except for the central system operator's fee.

As a general rule, the central system operator will initiate payment of the valid claim to the insured who has filed a claim within 10 days from the end of the month in which the claim was validated by the central system operator; if necessary, the payment may instead be performed at a later point. The payment may be full or partial compensation of the valid claim, which depends on the total number and size of valid claims in a certain month and the sum of all caps in the given month. In case of partial compensation of the valid claim in a certain month, the payment of the remainder of the valid claim will be included in the payment round in one or more subsequent months

Each insured understands that the central system operator accepts payments from insureds as the insured's payment collection agent and that the central system operator's obligation to pay the insured with a valid claim is subject to and conditional upon successful receipt of the associated payments from insureds. The central system operator does not guarantee payments by the central system operator to insureds with a valid claim for amounts that have not been successfully received by the central system operator from insureds.

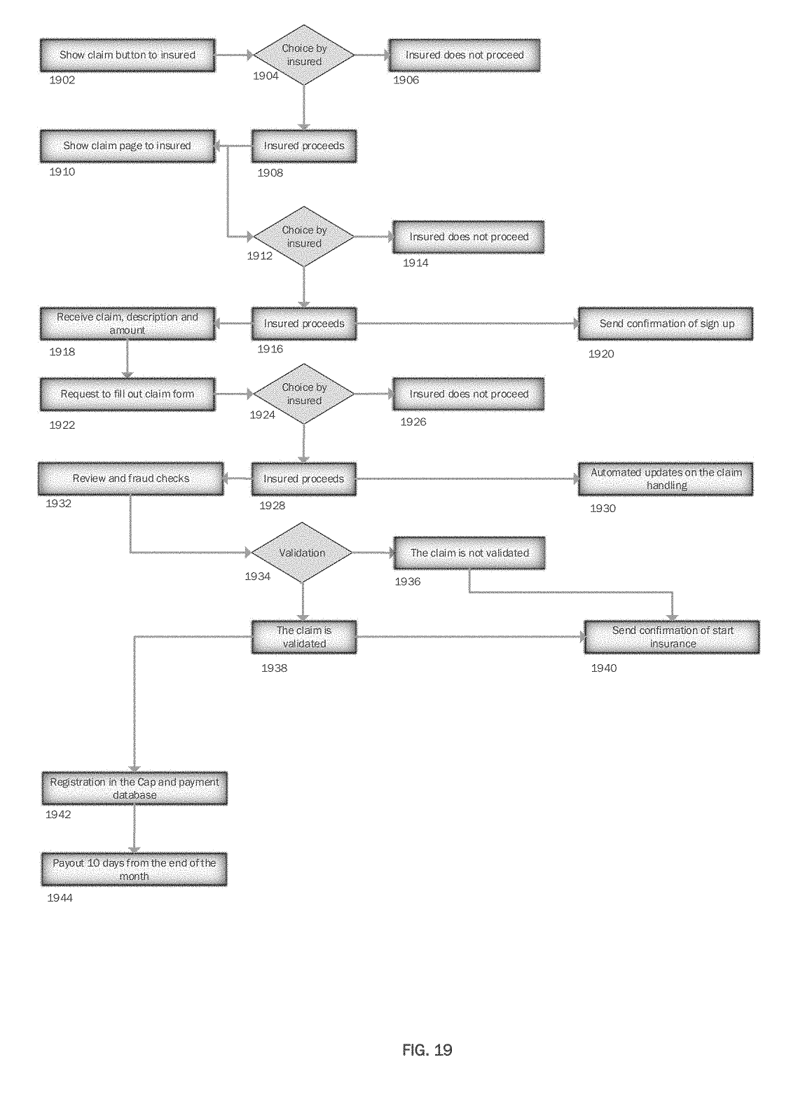

FIG. 19 shows a flowchart of how an insured files a claim from the perspective of the central system operator. The central system operator, through the server, shows a claim button to the insured (1902) with respect to an insurance. This can, e.g., be a cancel button regarding a phone, bike or travel insurance. The insured will then have to make a choice whether he or she wants to cancel the insurance (1904). The insured can either decide to not proceed (1906) or proceed by cancelling an insurance (1908). The central system operator, through the server, shows the claim page to the insured with various fields to fill out (1910). This can include, but is not limited to a description of the events that have caused the loss or damages, and an indication of the amount of the loss or damages.

The insured will then have to make a choice whether he or she fills out the form (1912). The insured can either decide to not proceed (1914) or proceed by filling out the form (1916). If the insured provides the information, the central system operator, through the server, will receive the claim, a description of the claim and the amount involved (1918).

The central system operator will then automatically, through the server, send a more detailed form to be filled out by the insured (1922). The insured will then have to make a choice whether he or she wants to cancel the insurance (1924). The insured can either decide to not proceed (1926) or proceed by filling out the form (1928).

If the insured provides the information, the central system operator, through the server, will start the review process, including various automated fraud checks (1932). The central system operator, through the server, will regularly send updates to the insured on the claim handling (1930).

The claim and system operator will, after the review and fraud check, come to the point of validation (1934). The central system operator will either validate (1938) or not validate the claim (1936). In both instances, the central system operator, through the server, will send the insured a confirmation on the decision.

If the central system operator validates the claim, this is registrated in the CPE of the server (1942). Payout of the claim amount, or a part thereof, will generally be performed within 10 days from the end of the month (1944).

D. The Automated Process to Determine the Cap-Based Quotes

Each insured appoints the central system operator as the insured's pricing and claim handling agent for the purpose of determining the cap for each insured. The central system operator sets in its sole discretion, on behalf of the insureds, the cap for insureds, based on both the information received from the user and the insurance terms.

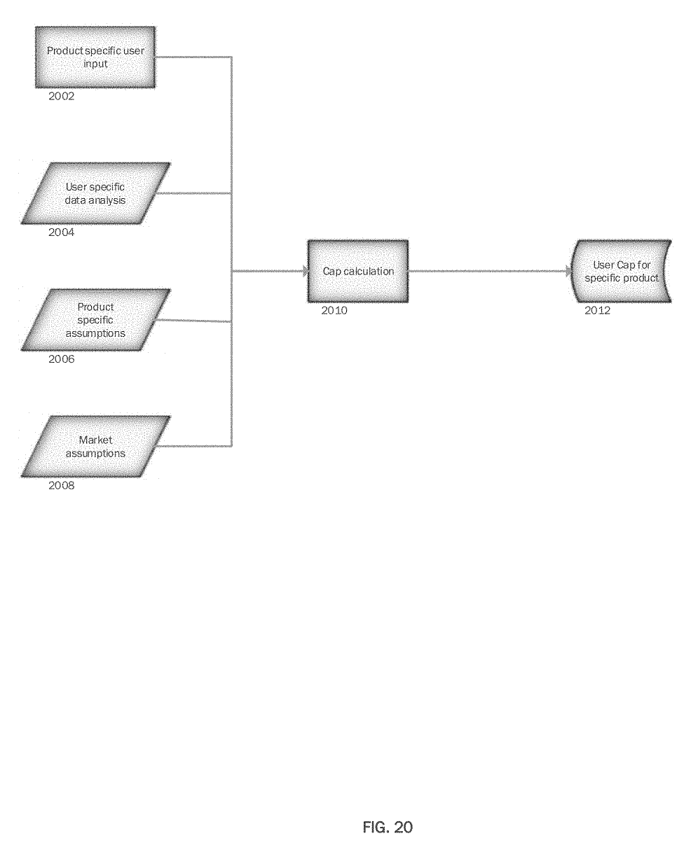

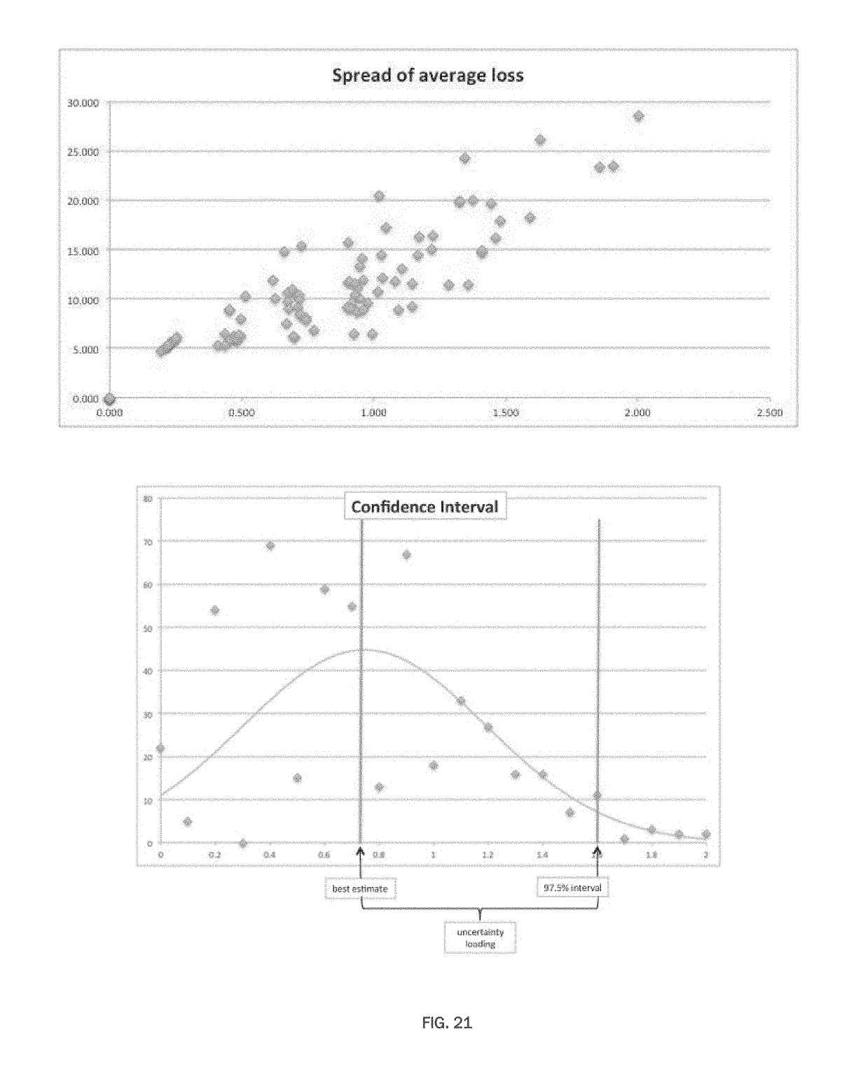

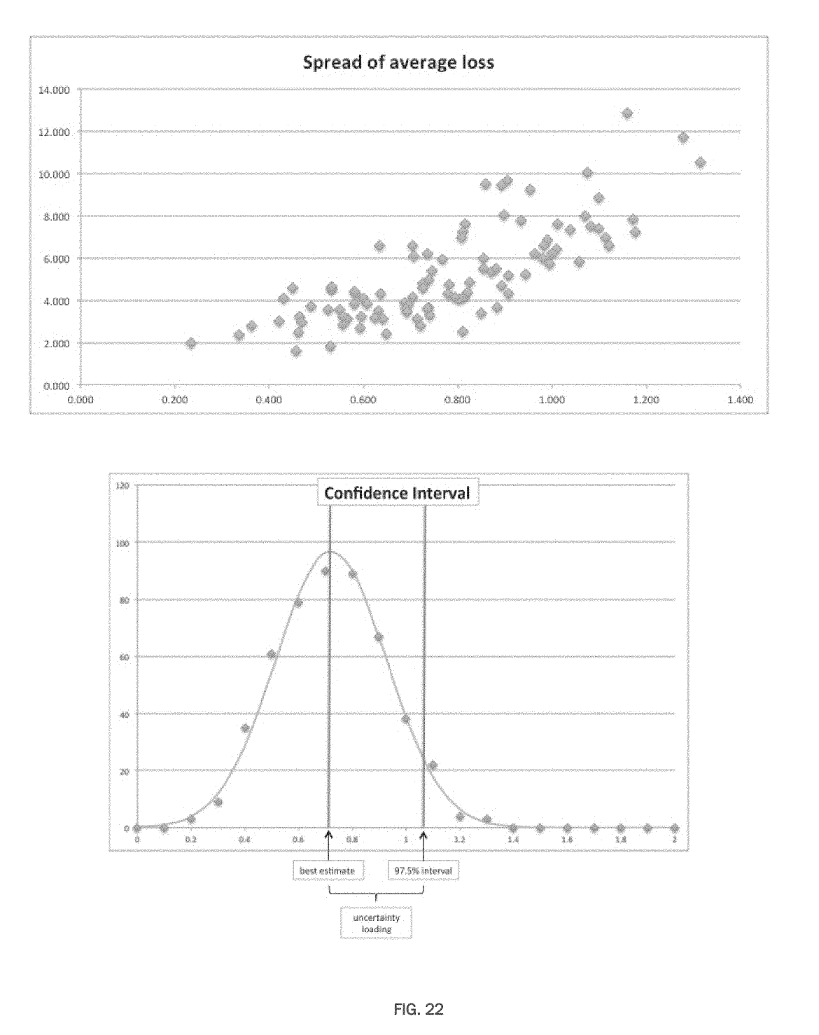

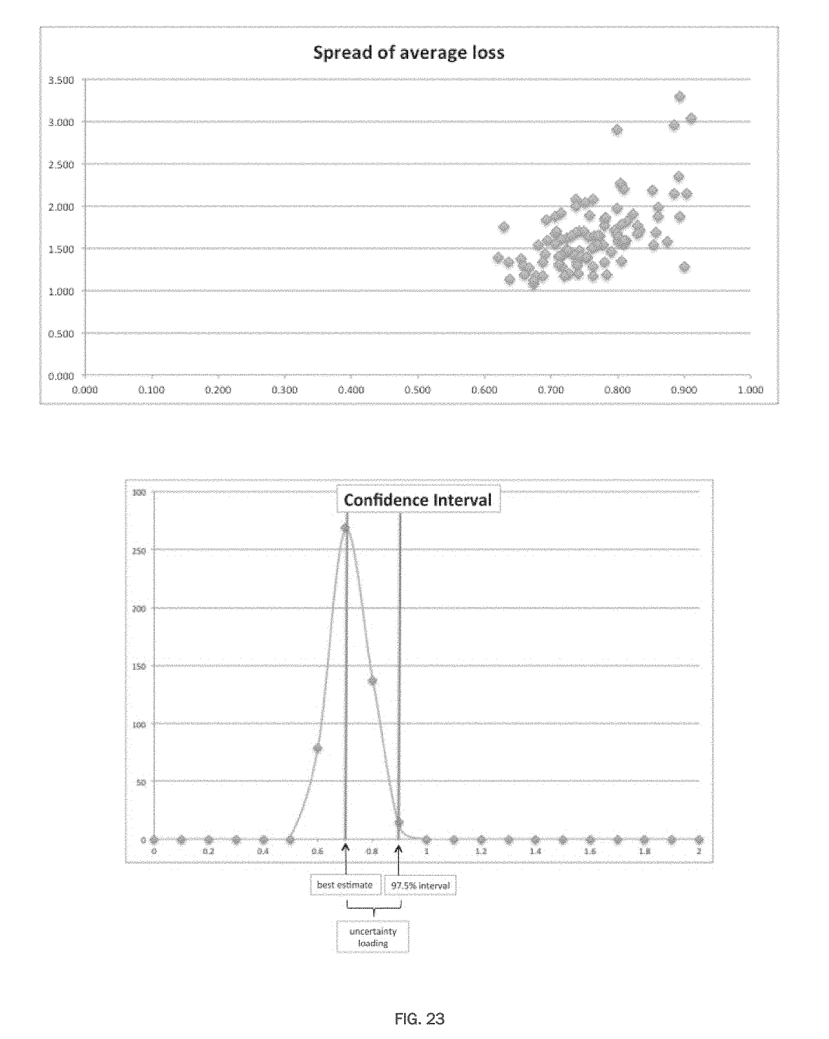

FIG. 20 shows the automated process to determine the cap-based quotes. To produce a user specific cap for a certain product a specific calculation is performed based on four types of input:
Product Specific User Input
User Specific Data Analysis
Product Specific Assumptions
Market Assumptions
   Product Specific User Input 2002 consists of the type of insurance a user chooses, the sum the user wants to insure, the type of product he/she wants to insure (e.g. city bike or racing bike), the main address of the insured goods, and the chosen insurance options.
   User Specific Data Analysis 2004 consists of the credit rating of the user, the payment option that is presented, and the insurance risk status. These factors are based on publicly available data or readily purchaseable data and/or internally collected data.
   Product Specific Assumptions 2006 consist of Uncertainty Loading (explained below) in combination with a Claims Frequency Estimator, a Claims Amount Estimator and Cost Loading. The Product Specific Assumptions are based on market data combined with expert judgment. These parameters will be updated periodically with the specific data generated from the product user database.
The Uncertainty Loading is a measure of how variable the losses are expected to be. This is calculated to help ensure that the cap is sufficient to cover all losses in one month 97.5% of the time and 99.5% in three months. With the available data 1,000 scenarios of the claim and payment process can be run. Statistical analysis is then used to determine the best estimate ratios and standard deviations. This leads to a confidence interval of the cap which satisfies the sufficiency parameters.
The Uncertainty Loading will likely decrease with the number of participants and with the increase of available data. The three examples in FIGS. 21-23 show this decrease of the uncertainty loading with larger number of participants. FIG. 21 shows the spread of average loss and confidence interval with 25 participants. FIG. 22 shows the spread of average loss and confidence interval with 100 participants. FIG. 23 shows the spread of average loss and confidence interval with 1,000 participants.
   Market Assumptions 2008 consist of Trend Factor and Seasonality Loading (explained below). These parameters are based on market data, trend reports and expert judgment.
The Trend Factor captures trends and likely near-future developments, economically (e.g. people tend to fill more claims during a recession), technologically (phoneblocks technology will lead to lower repair costs) and other.
The Seasonality Loading is added to capture the seasonal behaviour of some insurances, like travel insurance where most claims are made during the summer months. This loading is month dependent so that the cap is higher during high-risk periods.

The Cap Calculation module 2010 uses an algorithm to calculate a user specific cap for an insurance product 2012 from the parameters of these four input groups. This cap will be fixed for a predetermined period of time.

E. The Automated Monthly Collection of Contributions and Payment of Claim Amounts

If one or more claims qualify as a valid claim in a certain month, the central system operator will calculate the contribution per insured for the given month. Each insured appoints the central system operator as the insured's payment collection agent for the purpose of accepting the contributions from insureds. Each insured agrees that payment made by an insured through the central system operator, shall be considered the same as a payment made directly to an insured with a valid claim, except for the central system operator's fee.

In connection with a user entering into an insurance, he or she will be asked to provide customary billing information such as name, address and payment method information either to the central system operator or its third-party payment processor(s). The user agrees that the central system operator is allowed to collect the contribution, up to the cap, in connection with the user's account in accordance with the general terms by one of the methods described on the central system operator's site or application (e.g. the user's debit card, credit card, PayPal account or iDEAL account).

The user authorizes the collection of the contribution, up to the cap, by charging the selected payment method, either directly by the central system operator or indirectly, via a third-party online payment processor.

The central system operator, on behalf of the insureds, reserves the right, in its sole discretion, to (i) obtain a pre-authorization via the selected payment method or (ii) charge the payment method a nominal amount, not to exceed, for example, one US Dollar (USD 1), or a similar sum in the currency in which the user is transacting (e.g. one British pound), to verify the user's selected payment method.

As a general rule, collection of the contributions may be performed within 5 days of the end of the month; if necessary, contributions may instead be collected at a later point. The user will be notified by the central system operator immediately after the collection of a contribution. The invoice states the contribution, the method of payment and the fee collected by the central system operator. If the central system operator, through the server, cannot collect the contribution at the third attempt or 15 days after the payment instruction, whichever comes first, the central system operator can cancel the insurance. The insured has also no right to claim any damage that occurred during the period that the insured failed to pay the contribution.

As a general rule, the central system operator will initiate payment of the valid claim to the insured who has filed a claim within 10 days from the end of the month in which the claim was validated by the central system operator; if necessary, the payment may instead be performed at a later point. It may be the case, in exceptional circumstances, that the total claim amount in a certain month exceeds the total cap in that month, so that a small part of the total claim amount cannot be paid out in one month. The remainder will then be moved onto a ledger for payout in the subsequent month. These are so-called carried-over losses. The central system operator will calculate the contribution per insured based on both valid claims in the particular month and claims (partly) unpaid from the previous months. The central system operator may define a cut-off date after which the remainder is no longer moved onto a ledger but is cancelled. There are also alternatives for dealing with this tail risk, like reinsuring the risk that under exceptional circumstances the total claim amount may exceed the total cap in that month.

If a user owes any amount to the central system operator, on behalf of the insureds, then the central system operator may (but is not obliged to) withhold the amount owing to the central system operator from any payout amounts due to the specific insured, and use the withheld amount to set off the amount owed by the specific insured to the central system operator. If the central system operator does so, then the specific insured's obligation to pay the central system operator will be extinguished to the extent of the amount withheld by the central system operator, and the central system operator will cease to owe to the specific insured any obligations (including, but not limited to, any obligation to pay the specific insured) with respect to the amount withheld. In addition to the amount due, if the specific insured's account is delinquent or he or she otherwise has chargebacks on the account, the specific insured may be charged fees that are incidental to the central system operator's collection of these delinquent amounts and chargebacks. Such fees or charges may include collection fees, convenience fees, or other third-party charges.

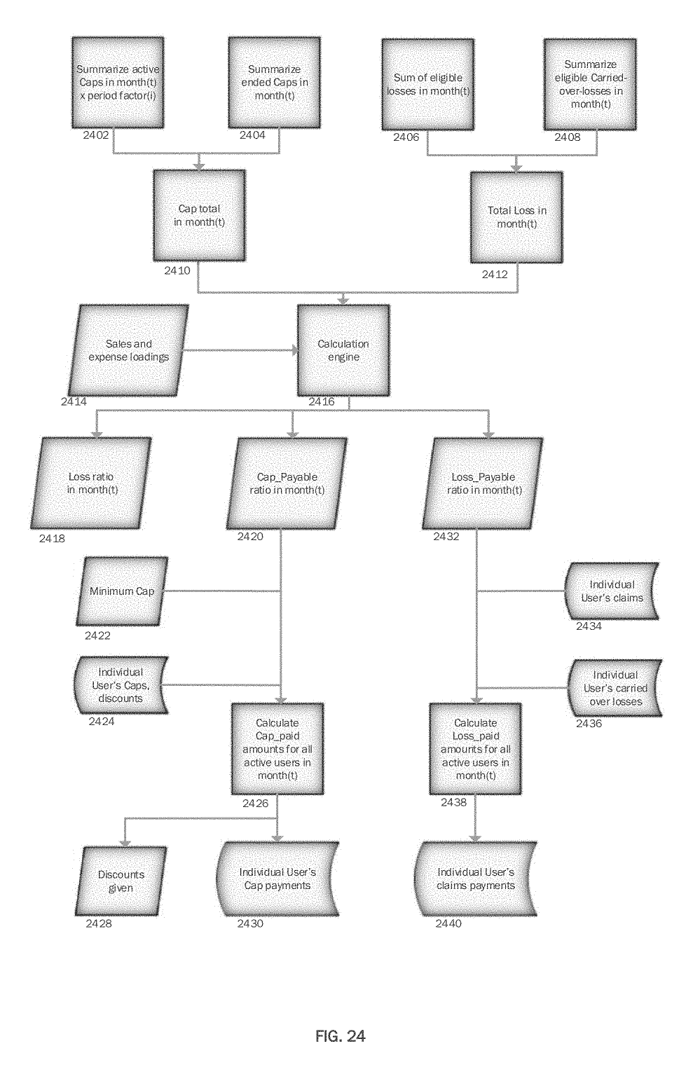

FIG. 24 shows the automated monthly collection of contributions and payment of claim amounts.

The CPE summarizes all full Caps of the products that were ended or cancelled in month(t) (2402). The CPE also summarizes the Caps (without discounts) of all participants that are active at the end of month(t). For a new participant the number of days from the start date of the policy is taken into account (i.e., if the policy started the 15th of the month, then only 15/30th of the CAP will be used) (2404). The CPE adds up amounts 2402 and 2404 to calculate the Cap Total for month(t) (2410).

The CPE summarizes all eligible Carried-over-losses in month(t). These are the non-paid parts of losses from previous months that have not been fully paid and that fall within the eligibility period (2406). The CPE summarizes all new losses that have been validated and accepted in month(t). If only part of a claim has been accepted then the accepted part will be added (2408). The CPE adds up amounts 2406 and 2408 to calculate Total Loss in month(t) (2412).

The CPE determines the sales and expense loadings for the product in month(t). This is a vector with default values and minimum values (2414).

The CPE calculates Loss ratio, Cap_Payable ratio and Loss_Payable ratio for month(t) based on 2410, 2412 and 2414. If 2412 is larger than 2410-2410 (default) than 2414 (minimum) is used in the calculation engine (2416).

The CPE generates the Loss ratio in month(t) calculated in 2416 (2418).

The CPE generates the Cap_Payable ratio in month(t) calculated in 2416 (2420). The CPE determines the minimum cap for the product in month(t) (2422). The CPE collects the individual users' caps and the individual users' discounts for the product in month(t) (2424). The CPE calculates with the Cap_Payable ratio (2420), the minimum cap (2422), the active users' caps and the active users' discounts (2424), the Cap_paid amounts (2426). The CPE generates the total amount of discounts given for this product in month(t) (2428). The CPE generates all the individual users' cap payments (2430).

The CPE generates the Loss_payable ratio in month(t) calculated in 2416 (2432). The CPE determines the individual user's claims that are validated and accepted in month(t) (2434). These are the same as used in 2406. The CPE determines the individual user's eligible carried-over-losses (2436). These are the same as in 2408. The CPE calculates the Loss_Payable ratio (2432), the individual user's carried-over losses (2434) and the individual user's claims (2436), the Loss_paid amounts for month(t) (2438). The CPE generates the individual user's claim payments and carried-over-loss payments (2440).

F. The Automated Product Lifecycle Controls

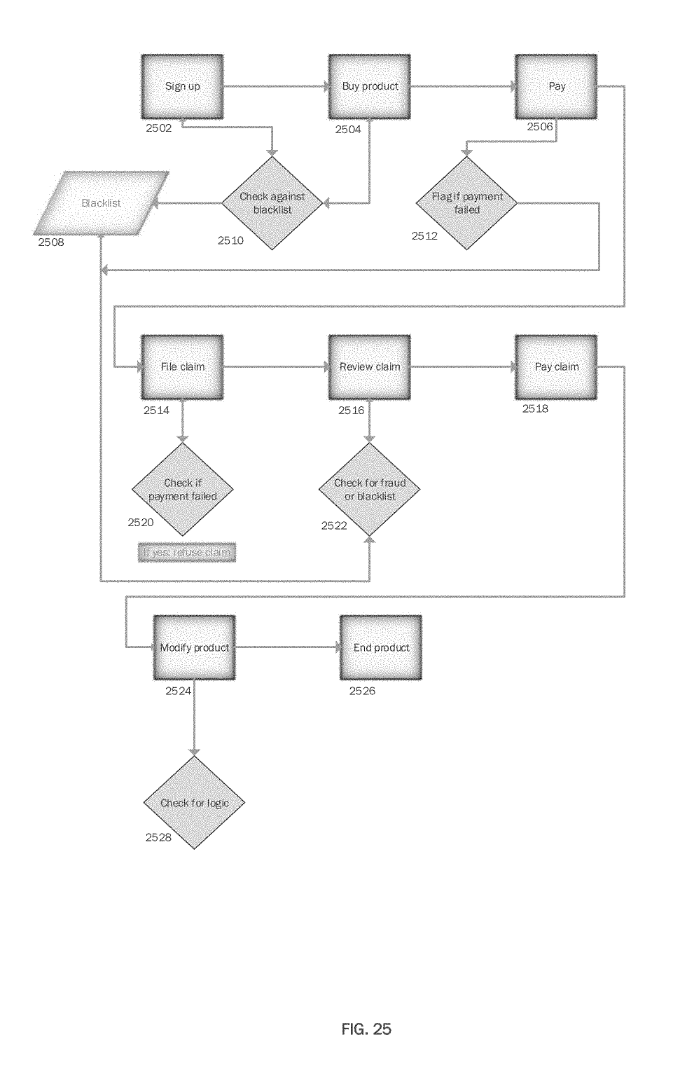

In order to verify the customer of an insurance, the system (the CPE, insurance portal and the central system operator) contains several automated and manual controls. FIG. 25 shows the automated product lifecycle controls.

During the sign-up process, where the participant signs up with Facebook, Google+ or his or her email address (2502), the system performs an automated check of the user input against a blacklist (2508) in order to block known bad customers (through email address and/or ip-address) (2510). The blacklist (2508) is a list of customers that are fraudulent, have overdue payments or are considered too risky. This list is partly automatically generated and partly generated by the central system operator's employees, both based on internally generated knowhow and external information from providers. Blacklist entries will stay there for a set amount of time (overdue payment is 2 years for example), after which they will be taken off the blacklist.

During the purchase process (2504), consisting of the entering into one or more insurances, a second blacklist check is performed (2510). The reason for this is twofold. Firstly, there is a time lag between sign-up and buying a product, in which the blacklist might contain additional information on the customer. Secondly, the customer needs to fill in more personal details which makes the second check more thorough.

If during the payment process (2506), the payment of a participant's actual contribution is refused or reversed, then the participant will be flagged. If a payment is flagged then the participant will receive a reminder and information on the consequences of not paying. When this happens a certain number of times, then the participant's insurances are cancelled and the participant is added to the blacklist (2512).

During the claim filing process (2514), the participant is checked against payment flags. If a payment is flagged, the claim is directly refused (2520).

During the claim review process (2516), there are automated checks for cancellation of the policy, payment status and blacklist status. Additional checks, both automated and manual, are performed to detect fraud (2522). If the claim is validated, the claim amount will be paid out to the insured (2518).

If a product is modified (2524), a check is applied with respect to the logic of the change. For example, if a participant changes his or her phone type from iPhone 6s to iPhone 7, this will trigger a check-up call (2528).

The product lifecycle ends when a product is cancelled or the product is ended (2526).

G. The Automated Risk Controls

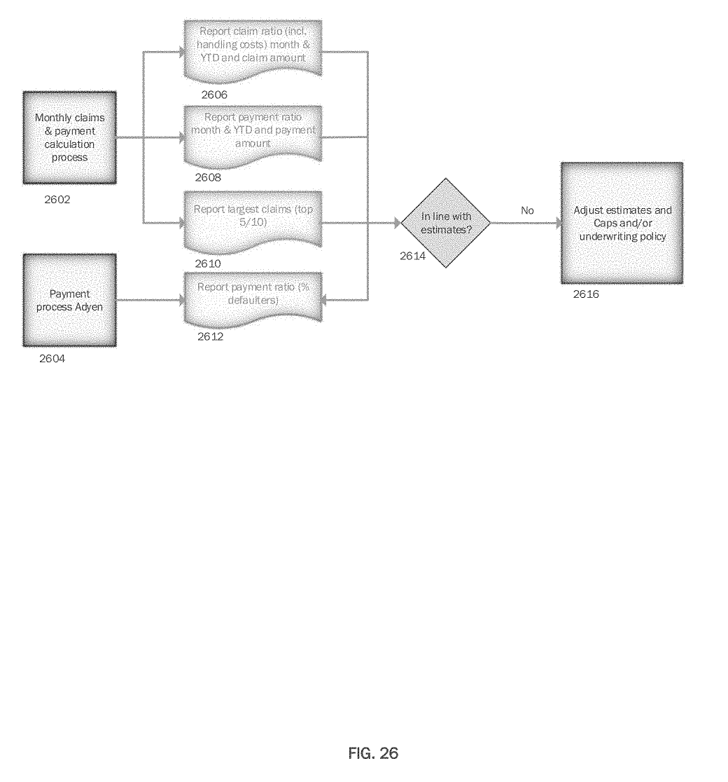

Automated risk controls are put in place to check the actual insurance data against the estimated numbers during the monthly claim and payment process, and allow for adjustment of the estimations and caps and/or underwriting policy. FIG. 26 shows the automated risk controls.

The monthly claim and payment calculation process (FIG. 24) will automatically generate several risk reports per product (2602):
The first report states the claim ratio, including handling costs both for the current month and year-to-date numbers and the total claims amounts for the current month and year-to-date (2606).
The second report states the payment ratio (what percentage of the cap needs to be collected) for the current month and year-to-date, and the total payment amounts (2608).
The third report will state the top 5/10 largest claims in the current month, with details on the claims (2610).

The payment collection process (2604) will generate a monthly report as well, stating the payment ratio, meaning the total collectable amount versus the total amount actually collected and the actual number of defectors. This is done both for the current month and year-to-date (2612).

The numbers in reports 2606, 2608, 2610, 2612 will be checked against the established ranges. If these ranges are exceeded then necessary actions will be undertaken (2614).

If the numbers exceed the pre-established ranges, this will lead to one or more of these actions:
update the claim frequency and claim amount estimates;
adjust the claim handling procedures; and
adjust the underwriting policy.

The caps will be updated accordingly (2616).

H. The Automated Claims and Cost Controls

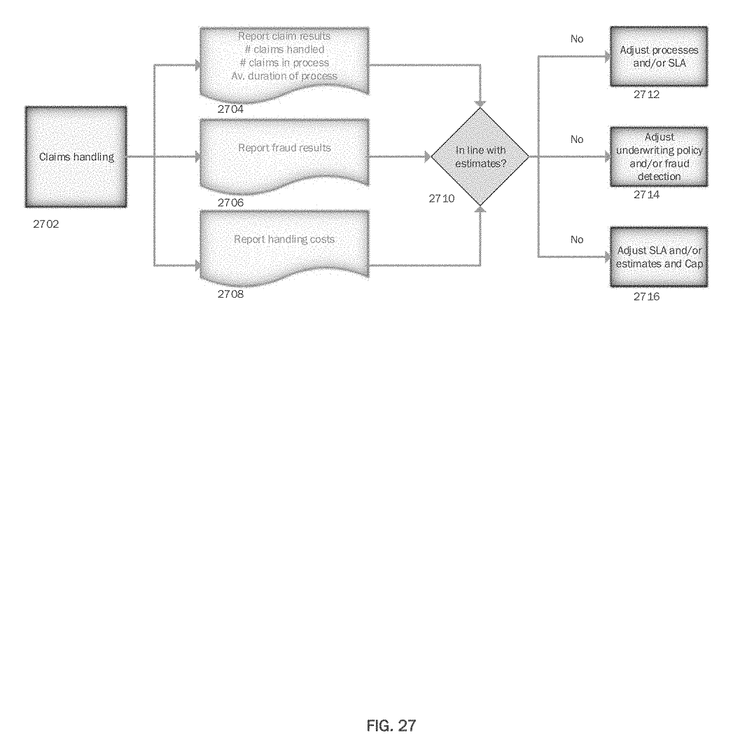

Automated claims and cost controls are in place to continuously monitor the actual costs of claim handling and fraud detection by the central system operator against the estimated cost amounts. FIG. 27 shows the automated claims and cost controls. The claims handling process (2702) will automatically generate several reports per product each month:
The first report states the number of claims handled, the number of claims still in process and the average duration of the claims process (2704).
The second report states the fraud detection results, automated and manual separately (2706).
The third report states the claims handling costs, total and per claim (2708).

The system checks the results from reports 2704, 2706 and 2708 against the estimated ranges. If the results will exceed the ranges this will lead to the following actions:
If the claim report results exceed the estimated range this will lead to an adjustment of the claims process or an adjustment of the Service Level Agreement (2712).
If the fraud detection reports exceed the estimation this will lead to an adjustment of the underwriting policy or an adjustment of the fraud detection procedures (2714).
If the claims handling costs exceed the estimated range this will lead to an adjustment of the Service Level Agreement and/or an adjustment of the estimations and an adjustment of the caps (2716).

I. The Automated Performance Controls

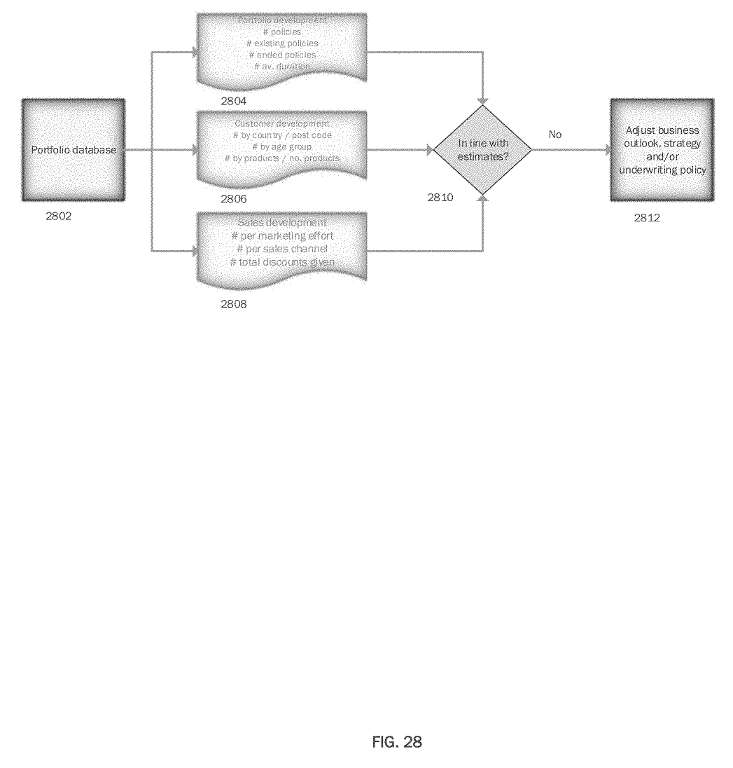

The automated performance controls will measure the performance of the portfolio development, including e.g. the number of policies, customers, margins, discounts given, as well as to notice and act against potential gaps in the checks. FIG. 28 shows the automated performance controls. The portfolio database holds the data for all the participants and all their active and cancelled products (2802). From here, the CPE generates on a monthly basis several reports:
The first report states the portfolio development, i.e. the number of new policies, number of existing policies, number of cancelled policies and the average duration of the policies (2804).
The second report states the customer development, broken down by country, zip code, age group, product, number of products. This will show growing and declining markets and contributes to identifying new opportunities (2806).
The third report states the results of sales efforts. The portfolio development will be broken down by marketing effort, by sales channel and discount group (2808).

The results from reports 2804, 2806 and 2808 will be analyzed and checked by the central system operator against the estimates (2810). If the results are not in line with the estimates, this will lead to an adjustment of the business outlook, an adjustment of the strategy, or an adjustment of the underwriting policy (2812).

The following provides an overview of how the example system and technology allow for a unique way to insure risks with several benefits:

(i) The technology allows for an insurance model where there is no payment of (upfront) insurance premiums. Insureds only pay if damages occur. This means that the user might pay less than his or her cap in a certain month, or even nothing at all. This is in stark contrast to the current global insurance system in which insurance is based on (upfront) premiums to be paid by insureds. In the current global insurance system, insurance companies rely heavily on asset management and income thereof while their primary focus should be on insuring people against particular risks. Insurance companies pass on costs of asset management purposes, operational costs and profits to the customer in the form of upfront, monthly premiums. Consequently, this traditional approach means insurance is out of the reach of many potential customers who cannot afford (or are otherwise unwilling) to pay for all the investments and operational costs charged by a traditional insurance provider as part of their premiums. Some may feel they are paying for nothing if over time they receive no payout (because no claim is submitted for a loss) but nonetheless continue to pay premiums. This leaves many customers without needed protection from certain losses that could otherwise be secured by insurance. (ii) The described system and technology allows for a unique way to insure risks with several benefits, by automatically translating actual claims into contributions at the end of the month or even real-time. This means that insureds are being charged only for risks that materialize and immediately when they occur or shortly thereafter. They pay the real price of insurance. This s in stark contrast to the current global system in which insurance premiums are paid upfront and are not related to actual and current risks that materialize. One of the main benefits is that protection becomes fundamentally less expensive, by cutting out payments for asset management purposes and operational costs, and thus protection will become available to more people.
(iii) The technology allows to automatically discount a change in the risk distribution into the price of the insurance product. The actual monthly contribution to be paid by an insured is dynamic, determined after the end of each month (or other period). If the risk distribution of an insurance over time changes, the individual and aggregate actual contributions will automatically change in accordance with the change in the risk distribution. The central system operator may, besides the cap for an insurance product, also show in real-time the expected actual contribution to be made by insured entities at the end of the time period, this expected actual contribution being based on historical claims and contributions data and the number of claims submitted so far in the relevant time period. In the current global insurance system, the price of the insurance product cannot automatically change if there is a change in the risk distribution, because the upfront premium that an insurance carrier charges is fixed. This makes that premiums of insurance companies often deviate from the actual risk distribution of an insurance.
(iv) The central system operator may charge users a certain percentage of the total claims to be paid out to cover costs of operating the platform. Alternatively, the central system operator may charge (i) a (small) one-off subscription fee or (ii) a (small) monthly contribution to cover some or all of the costs related to operating the platform.
(v) The technology allows to automatically discount claim outliers in the price of the insurance product, in the sense of higher than expected aggregate claim amounts in a certain period, into the fee of the central system operator. In case of claims outside a prefixed distribution, the fee percentage charged by the central system operator can automatically decrease to mitigate the effect of the outliers.
(vi) The technology allows to use internally generated data (e.g. website and app usage data, payment data and claim data) as well as third party data (from companies such as Facebook, Google+, PayPal, banks, card companies and other companies generating data that can be used to assess individual and collective risk distributions) in order to set the right cap of an individual or a group of insureds.
(vii) The technology allows to calculate and disclose the estimated actual monthly contribution of each insured in a future period. Based on historical payment and claim data, the central system operator produces real-time estimates of the actual contribution that an individual insured will likely have to pay in a future period and the amount the insured will likely save compared to the individual cap.
(viii) The technology allows for full transparency, which makes it possible to show the insureds of a particular insurance in a specific country a complete breakdown of the actual contributions into sources, such as the amount paid out to the insured with a valid clam, the fee charged by the central system operator, and how this fees breaks down into sources such as claim handling and marketing.
(ix) The technology allows for global forms of insurance. Where traditional insurance carriers are often constrained by solvency requirements on a national level, this technology allows for combining risk groups on a global scale. This will make it possible to ultimately insure persons in areas of particular risk (e.g. areas which are more susceptible to natural disasters or terrorist attacks).
(x) The technology allows for several add-ons to mitigate cross-border inconveniences. A first example is the usage of location-based services (e.g. a user flying from New York to Mexico City is asked to activate travel insurance when he lands). A second example is the acceptance of cryptocurrencies such as Bitcoins to mitigate the inconveniences related to dealing with multiple currencies.

As discussed, in example implementations, participants do not pay (upfront) premiums, but rather only a contribution when damages occur in a group of users or otherwise when a claim is filed. In alternative implementations and variations to the model, users may (i) pay a (small) one-off subscription fee or (ii) a (small) monthly upfront contribution to cover some or all of the costs related to operating the platform. It should be appreciated, however, that such a fee/monthly contribution is unrelated to, and does not include, any contributions or amounts paid by insured entities to cover payment of claims; such contributions (amounts due) from users are always based on actual amounts paid for valid claims. Unlike the fees/contributions for operations costs, the amounts due for valid claims (if any) can be highly variable, as the amounts due are recalculated each period and are dependent on actual disbursements to be paid to users with valid claims in that period.

Exemplary methods and systems for coverage against loss with claim-based contributions involve presenting no premium insurance options through a portal, and determining, after receipt of certain information from the potential insured entity, a cap-based quote to limit a user's upward risk. According to this computer-implemented method, insured entities are being charged only for risks that materialize and immediately when they occur. This is in stark contrast to the current global system in which insurance premiums are paid upfront and are not related to actual and current risks that materialize. Users are provided the coverage terms and a cap-based quote, which is at least partly based on the level of risk of the user. A preferred payment method and payment details are collected from the user for automated electronic payments initiated by a centralized system. Contributions by insured entities are based on the actual amount to be paid for valid claims in a month (or other time period) and the insured entities' risk profiles (and certain other parameters), and may be zero for the month if there are no claims. The claim-based contributions are automatically collected from the insured entities. An insured entity who has submitted a valid claim will receive compensation based on contributions of other entities.

The present invention has been described in terms of one or more preferred embodiments, and it should be appreciated that many equivalents, alternatives, variations, additions, and modifications, aside from those expressly stated, and apart from combining the different features of the foregoing embodiments in varying ways, can be made and are within the scope of the invention. In the above description, a number of specific details, examples, and scenarios are set forth in order to provide a better understanding of the present disclosure. These examples and scenarios are provided for illustration, and are not intended to limit the disclosure in any way. The true scope of the invention will be defined by the claims included in this and any later-filed patent applications in the same family.

The computerized functionality described above may be implemented in hardware, firmware, software, single integrated devices, multiple devices in wired or wireless communication, or any combination thereof. Computerized functions may be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory. In the drawings, specific arrangements or orderings of schematic elements may be shown for ease of description. However, the specific ordering or arrangement of such elements is not meant to imply that a particular order or sequence of processing, or separation of processes, is required in all embodiments. Further, some connections or relationships between elements may be simplified or not shown in the drawings so as not to obscure the disclosure. This disclosure is to be considered as exemplary and not restrictive in character, and all changes and modifications that come within the spirit of the disclosure are desired to be protected.

We claim:

1. A computer-implemented method for providing coverage against loss, comprising:
a. presenting to a user, via a networked computing device, no premium insurance options through a portal;
b. accepting from the user, at one or more processors, information sufficient to generate a level of risk for covering the user in case of a loss;
c. determining, using one or more processors, a cap-based quote, the cap being based at least in part on the level of risk of the user;
d. presenting to the user, via the computing device, the cap-based quote and the option to take out an insurance policy;
e. collecting, at one or more processors, a preferred payment method and payment details from the user to be used for automated electronic payments to be initiated by a centralized computing system;
f. issuing to the user, using one or more processors, an insurance policy to allow the user to join a pool of insured entities and thereby obtain insurance coverage without making any payment with a cap that is calculated based on the level of risk.

2. The method of claim 1, wherein the no premium insurance options include options to protect against a specified loss without any payment when the insurance policy is issued, and further without any subsequent payment unless and until at least one other insured entity covered under an insurance policy is to be paid for a valid claim.

3. A computer-implemented method for providing coverage against loss, comprising:
a. presenting, by one or more processors, to an insured entity covered under a no premium insurance policy the option to file a claim for a loss under the no premium insurance policy, wherein the no premium insurance policy covers a pool of insured entities;
b. collecting, at one or more processors, an amount of the loss for the insured entity with a valid claim;
c. determining, using one or more processors, the total claim amount claimed in a given time period by all insured entities with valid claims in the pool of insured entities;
d. determining, by one or more processors, a contribution amount to be contributed by each of the insured entities in the given period, the contribution amount being based on the total claim amount and being limited by a corresponding cap for each insured entity;
e. transmitting, by one or more processors, payment requests for the contribution amount to corresponding payment service providers selected by each of the insured entities; and
f. providing, by one or more processors, compensation to the insured entity with a valid claim based on the contribution amounts paid by insured entities in the pool in the given time period.

4. The method of claim 3, wherein the no premium insurance options include options to protect against a specified loss without any payment when the insurance policy is issued, and further without any subsequent payment unless and until at least one other insured entity covered under an insurance policy is to be paid for a valid claim.

5. One or more storage devices storing instructions that are executable by one or more processors to perform operations comprising:
a. determining a total claim amount claimed in a given time period by insured entities covered under a no premium insurance policy;
b. determining the actual amount to be contributed by the insured entities in a given period, based on the total claim amount, constrained by a cap-based quote for each individual insured entity;
c. transmitting payment requests for the contribution amount to payment service providers selected by each of the insured entities; and
d. providing compensation to an insured entity who has submitted a valid claim, the compensation being based on contributions of other entities insured under the no premium insurance policy during the time period.

6. The method of claim 5, wherein the no premium insurance options include options to protect against a specified loss without any payment when the insurance policy is issued, and further without any subsequent payment unless and until at least one other insured entity covered under an insurance policy is to be paid for a valid claim.
